(19) United States
(12) Patent Application Publication
(10) Pub. No.: US 2015/0379201 A1
(43) Pub. Date: Dec. 31, 2015

(54) System and Method for Personal Healthcare Analysis and Distributable Archive

(71) Applicants: Sridhar Varadarajan, Bangalore (IN); Sridhar Gangadharpalli, Bangalore (IN); Amit Thawani, Bangalore (IN)

(72) Inventors: Sridhar Varadarajan, Bangalore (IN); Sridhar Gangadharpalli, Bangalore (IN); Amit Thawani, Bangalore (IN)

(73) Assignee: SRM INSTITUTE OF SCIENCE AND TECHNOLOGY, West Mambalam (IN)

(21) Appl. No.: 14/315,292

(22) Filed: Jun. 25, 2014

(51) Int. Cl. G06F 19/00; G06F 17/30

(52) U.S. Cl. CPC G06F 19/322; G06F 17/30324

(57) ABSTRACT

An individual has a large number of health related transactions during their lifecycle right from birth. As technology is fast evolving and medical profession demanding accurate description of a situation for effective handling of the patients, it is very useful, and often a necessity, to keep a record of all of the health related transactions. A system and method for recording the large and growing number of health transactions in a structured manner, analyzing and relating of the same, and making them available to any agency is described. The structuring of the transactions is based on a set of dimensions and the analysis leads to the linking of the transactions across these dimensions and deriving of the meta-information for assisting the individual to be more health conscious.

### FIELD OF THE INVENTION

The present invention relates to the healthcare analysis in general, and more particularly, analysis of personal healthcare records of individuals. Still more particularly, the present invention relates to a system and method for the structuring and analysis of personal healthcare records for achieving distributable archiving and for increasing health consciousness.

### BACKGROUND OF THE INVENTION

Healthcare is an important aspect of a society and it is a mandate for the society to ensure that every person on this planet remains healthy. The whole gamut of hospitals, doctors, nurses, labs, technicians, pharmacists, health advisors, and insurance agencies collectively assure the well being of the society in general and the individuals in particular. While attending to an individual, a doctor would have several questions about the individual especially related to just past activities and illnesses. How accurately can such questions be answered? A good medication leading to a quicker recovery many a times depend on the accuracy of the above answers. How many individuals can answer such questions accurately? More importantly, is it possible for a layman to understand comprehensively the questions of medical professionals' let alone confidently answering them. In order to handle this situation, several technologies and open standards are being developed: technologies help achieve comprehensiveness and standards help in global adaptation. The Unified Medical Language System (http://umlsks.nlm.nih.gov) is an initiative of US National Library of Medicine. UMLS is a comprehensive repository of biomedical vocabularies. The UMLS provides 900,000 concepts in which over two million names are integrated. Further, these concepts are derived from sixty families of biomedical vocabularies and provide twelve million relations among these concepts. UMLS Metathesaurus includes Vocabularies derived from the NCBI taxonomy (National Center for Biotechnology Information), Gene Ontology, the Medical Subject Headings (MeSH), OMIM (Online Mendelian Inheritance in Man) and the Digital Anatomist Symbolic Knowledge Base. One of the interesting features of UMLS is that concepts are not only inter-related, but may also be linked to external resources such as GenBank. The UMLS knowledge sources are updated quarterly. Also, UMLS includes tools for customizing the Metathesaurus known as “MetamorphoSys”, and a tool for generating lexical variants of concept names called “Ivg”, and for extracting UMLS concepts from text called “MetaMap.” Similarly, SNOMED (Systematized Nomenclature of Medicine) represents a standardized clinical terminology which is the most comprehensive, multilingual healthcare terminology available (as on August 2010) (http://www.ihtsdo.org/snomed-ct/). SNOMED provides a comprehensive nomenclature of clinical medicine for facilitating accurate storing and retrieving healthcare records in human and veterinary medicine. In SNOMED, diseases and procedures are ordered hierarchically and are further referenced back to more elementary terms of medical terminology. SNOMED's reference ontology has a Multi-Axial Design, with 11 axes. SNOMED is designed for representing complex concepts defined in term of simpler ones. A disease for instance can be defined in terms of its abnormal anatomy, abnormal functions and morphology. This in some cases helps identify the relations between a disease to an infectious agent, or a chemical or pharmaceutical agent. From the standardization point of view, for instance, the efforts of openEHR (http://www.openehr.org/home.html) initiative provide an elaborate description of electronic health records (EHRs): it is about enabling technology to effectively support healthcare, medical research, and related areas and providing of semantically enabled health computing platform. Its objective is to support adaptable health computing systems and patient-centric electronic health records. While this addresses the bulk of the information to be cataloged, it is placed on record that multiple viewpoints need to be addressed with patient-centric being one of them and this leads to the notion of person-centric health records as an individual transitions from being healthy to a patient state and hence, it is equally important to catalog what happens when the individual is healthy. The present invention is related to the issue of collecting, organizing, and analyzing of the individual's heath related records: the system, Personal Healthcare Analysis and Distributable Archiving (pHANDA), effectively addresses this requirement.

### DESCRIPTION OF RELATED ART

U.S. Pat. No. 7,707,047 to Hasan; Malik M. (Las Vegas, Nev.), Peterson; John C. (Tucson, Ariz.), Wallen; J. Dominic (Tucson, Ariz.) for “Method and system for generating personal/individual health records” (issued on Apr. 27, 2010 and assigned to HealthTrio LLC (Centennial, Colo.)) a system and method for generating and/or updating a personal/individual health record, wherein inputs of data to the system may come from diverse sources including, but not limited to, patient questionnaires, insurance company claims data, hospitals, clinics and other institutional providers, and individual physicians and physicians' offices.

U.S. Pat. No. 7,647,320 to Mok; Megan Wai-Han (Pacifica, Calif.), Jopling; Arthur Douglas (San Rafael, Calif.), Holvey; R. David (Pacifica, Calif.), Mattox; Joel D. (Saratoga, Calif.) for “Patient directed system and method for managing medical information” (issued on Jan. 12, 2010 and assigned to Peoplechart Corporation (San Francisco, Calif.)) describes a system and method for the management of a patient's medical records by a central data repository under the direction of the patient and enabled by an entity managing records on behalf of the patient.

U.S. Pat. No. 7,621,445 to Esseiva; Effron F. D. (Bowen Island, Calif.), Kol; Tomer (Yoqneam Illit, Ill.), Stevens; Richard J. (Rochester, Minn.) for “Method and apparatus for access to health data with portable media” (issued on Nov. 24, 2009 and assigned to International Business Machines Corporation (Armonk, N.Y.)) describes a method and apparatus for managing electronic medical records that includes defining a tiered hierarchy of medical record storage categories.

U.S. Pat. No. 7,613,620 to Salwan; Angadbir Singh (Potomac, Md.) for “Physician to patient network system for real-time electronic communications and transfer of patient health information” (issued on Nov. 3, 2009) describes a physician to patient network system that is a private and secure infrastructure for independently practicing physicians and patients for real-time electronic communication and transfer of patient health information.

U.S. Pat. No. 7,487,102 to Castille; Debra (Harrisonville, Mo.) for “Process of interfacing a patient indirectly with their own electronic medical records” (issued on Feb. 3, 2009) describes a process of allowing a patient to have limited input access to their electronic medical record including providing the patient with a machine readable medical questionnaire concerning their history, environment, symptoms, and other pertinent information for answering by the patient and updating the patient's medical records.

U.S. Pat. No. 7,454,359 to Rosenfeld; Brian A. (Baltimore, Md.), Breslow; Michael (Lutherville, Md.) for “System and method for displaying a health status of hospitalized patients” (issued on Nov. 18, 2008 and assigned to VISICU, Inc. (Baltimore, Md.)) describes a system and method for displaying a health status of hospitalized patients wherein patient data associated with hospitalized patients is selected according to display rules.

U.S. Pat. No. 7,379,946 to Carus; Alwin B. (Waban, Mass.), Ogrinc; Harry J. (Westwood, Mass.) for “Categorization of information using natural language processing and predefined templates” (issued on May 27, 2008 and assigned to Dictaphone Corporation (Stratford, Conn.)) describes methods and systems for classifying and normalizing information using a combination of traditional data input methods, natural language processing, and predetermined templates.

U.S. Pat. No. 5,867,821 to Ballantyne; Douglas J. (Nepean, Calif.), Mulhall; Michael (Ottawa, Calif.) for “Method and apparatus for electronically accessing and distributing personal health care information and services in hospitals and homes” (issued on Feb. 2, 1999 and assigned to Paxton Developments Inc. (Ottawa, Calif.)) describes a system for the distribution and administration of medical services, entertainment services, electronic medical records, educational information, etc. to a patient's individual electronic patient care station (PCS) interconnected to a master library (ML) which stores data in digital compressed format, through a local medical information network.

“Management and maintenance policies for EHR interoperability resources” by Kalra; Dipak, Freriks; Gerard, Mennerat; Francois, Devlies; Jos, Tapuria; Archana, and Thienpont; Geert (a report, Q-REC Project, European Quality Labelling and Certification of Electronic Health Record Systems, 2008) describes the quality management and maintenance landscape for four kinds of resource that support the interoperability of electronic health records, namely, Clinical archetypes, Open source components and XML Schemas, Legislative and industry standards, and Coding schemes and terminology systems.

“Electronic Health Records Overview” by The MITRE Corporation (a research report, MITRE Center for Enterprise Modernization McLean, Va., April 2006) provides an overview of the features and functions of major commercial electronic health records.

“HIMSS Electronic Health Record Definitional Model Version 1.1” by HIMSS Electronic Health Record Committee (a report, 24 Sep. 2003) describes an operational EHR definition and key attributes to support the measurement of the penetration of electronic health records in health systems.

“Archetypes—Constraint-based Domain Models for Futureproof Information Systems” by Beale; Thomas (appeared as a report, www.deepthought.com.au, 21 Aug. 2001) describes a formal language for archetypes for modeling and describing electronic health records.

The known systems do not address the issue of systematically gathering of person-centric health records, structuring and correlating of these records leading to the achieving of high level of health consciousness and distributability of the heath records. The present invention provides for a system and method for personal healthcare analysis and distributable archiving.

### SUMMARY OF THE INVENTION

The primary objective of the invention is to build a person-centric health records to help enhance effective healthcare and increase health consciousness in an individual.

One aspect of the present invention is to be able to distribute the archived personal health records of the individual to multiple stakeholders.

Another aspect of the present invention is to manage the personal health records along six dimensions, namely, Accident (A), Disease (D), Environment (E), Narration (N), Observation (0), and Lifestyle (L).

Yet another aspect of the present invention is to further identify sub-dimensions of each of the six dimensions.

Another aspect of the present invention is to structure the personal health records of the individual along the six dimensions and sub-dimensions based on health related activities, actions, and events associated with the individual.

Yet another aspect of the present invention is to relate the raw input from multiple sources to generate dimension mapped data.

Another aspect of the present invention is to correlate the dimension mapped data to generate dimension linked data.

Yet another aspect of the present invention is to discover meta-dimension data based on the dimension linked data.

Another aspect of the present invention is to use support knowledge sources.

Yet another aspect of the present invention is use the notion of actflows in the generation of dimension linked data.

Another aspect of the present invention is to use the notion of autoflows in the generation of dimension linked data.

Yet another aspect of the present invention is to generate sequences of personal heath records based on actflows and autoflows.

Another aspect of the present invention is to assign a label for the generated sequence.

Yet another aspect of the present invention is to generate clusters of personal health records based on autoflows.

Another aspect of the present invention is to use the notion of link dimensions as part of the autoflows.

Yet another aspect of the present invention is to generate meta-clusters based on labeled sequences and clusters.

Another aspect of the present invention is to use the notion of set-theoretic operators, metaflows and auto-discovery in the generation of meta-sequences and meta-clusters.

In a preferred embodiment the present invention provides a system for analysis of and distributable archiving of a plurality of personal health records in a personal health database of a person based on a plurality of health related activities, a plurality of health related events, and a plurality of health related actions associated with said person, resulting in a plurality of sequences of said personal health records, a plurality of clusters of said personal health records, a plurality of meta-sequences of said plurality of sequences, and a plurality of meta-clusters of said plurality of clusters and said plurality of sequences, said system comprising:
means for obtaining a plurality of raw data records based on said plurality of health related activities, said plurality of health related events, and said plurality of health related actions, and for making of said plurality raw data records as a part of said personal health database;
means for obtaining of a plurality of dimensions comprising of an accident dimension, a disease dimension, an environment dimension, a narration dimension, an observation dimension, and a lifestyle dimension, and for obtaining of a plurality of sub-dimensions for each of said plurality of dimensions,
means for relating of said plurality of raw data records into a plurality of dimension mapped records, wherein a record dimension of a dimension mapped record of said plurality of dimension mapped records is a dimension of said plurality of dimensions and a sub-dimension of a plurality of sub-dimensions associated with said dimension, and for making of said plurality of dimension mapped records a part of said personal health database;
means for correlating of said plurality of dimension mapped records to generate a plurality of dimension linked records, wherein a dimension linked record of said plurality of dimension linked records is a sequence of said plurality of personal health records of said personal health database, wherein said sequence is a part of said plurality of sequences or a cluster of said plurality of personal health records of said personal health database, wherein said cluster is a part of said plurality of clusters, and for making of said plurality of dimension linked records a part of said personal health database; and
means for discovering a plurality of meta-dimension records based on said plurality of sequences and said plurality of clusters resulting in a plurality of meta-dimension records, wherein a meta-dimension record of said plurality of meta-dimension records is a meta-sequence of said plurality of sequences, wherein said meta-sequence is a part of said plurality meta-sequences or a meta-cluster of said plurality of clusters, wherein said meta-cluster is a part of said plurality of meta-clusters, and for making of said plurality of meta-dimension records a part of said personal health database.
(BASED ON FIGS. 1, 2, 2A, 3, and 3A)

### BRIEF DESCRIPTION OF THE DRAWINGS

FIG. 1 describes the overall Positioning of pHANDA System.

FIG. 2 describes briefly the Multiple Dimensions of pHANDA System.

FIG. 2A provides an illustrative list of Sub-Dimensions.

FIG. 3 provides an overview of pHANDA System.

FIG. 3A provides a flow description of pHANDA System.

FIG. 4 provides an illustrative list of Sources of raw Data.

FIG. 4A provides an illustrative Dimension Mapping.

FIG. 4B depicts an illustrative Flow of Data Acquisition.

FIG. 5 provides an Approach for Dimension Mapping.

FIG. 5A provides additional information related to the Approach for Dimension Mapping.

FIG. 5B provides some more information related to the Approach for Dimension Mapping.

FIG. 6 provides an illustrative Mapped Data—Accident Dimension.

FIG. 6A provides an illustrative Mapped Data—Disease Dimension.

FIG. 6B provides an illustrative Mapped Data—Environment Dimension.

FIG. 6C provides an illustrative Mapped Data—Narration Dimension.

FIG. 6D provides an illustrative Mapped Data—Observation Dimension.

FIG. 6E provides an illustrative Mapped Data—LifeStyle Dimension.

FIG. 7 depicts approaches for Linking across Dimensions.

FIG. 7A provides an approach for obtaining an ActFlow.

FIG. 7B provides an ActFlow based approach for Linking across Dimensions.

FIG. 7C provides an AutoFlow based Approach for Linking across Dimensions.

FIG. 7D provides additional information related to the AutoFlow based Approach for Linking across Dimensions.

FIG. 8 depicts an illustrative ActFlow.

FIG. 8A depicts an illustrative Sequence.

FIG. 9 describes an approach for Discovery.

FIG. 9A provides an approach for obtaining a MetaFlow.

FIG. 9B describes additional approaches for Discovery.

FIG. 10 depicts an illustrative Meta-Cluster.

FIG. 10A depicts an illustrative MetaFlow.

FIG. 10B provides an illustration of Discovery—Abstraction (similarity measure based).

FIG. 10C depicts an illustration of Label Hierarchy.

FIG. 11 depicts an illustrative computational pHANDA system.

FIG. 12 depicts several computational platforms for deploying pHANDA system.

FIG. 13 provides an approach for labeling a cluster of dimension mapped records.

FIG. 14 elaborates on an approach for discovering meta-clusters.

### DETAILED DESCRIPTION OF THE PREFERRED EMBODIMENTS

An individual gets involved in a large volume of healthcare related transactions that ever grows with time. Right from birth, there are several activities by an individual or related to the individual leading to health related actions and events. With time, these activities, actions, and events would have much impact on the well being of the individual as future activities can be well guided if the past activities are well tracked: the need is to collect and organize these voluminous transactions so that most of the queries regarding the health of the individual get answered in the most appropriate manner. Consider the following scenario: a person meets with an accident and is brought to the hospital in the semi-conscious state; the physician handling the patient needs to understand the allergic characteristics of the patient so that proper treatment can be administered. How to answer this question as quickly as possible and as accurately as possible as the patient needs to be treated immediately? The proposed invention addresses this and many such instances.

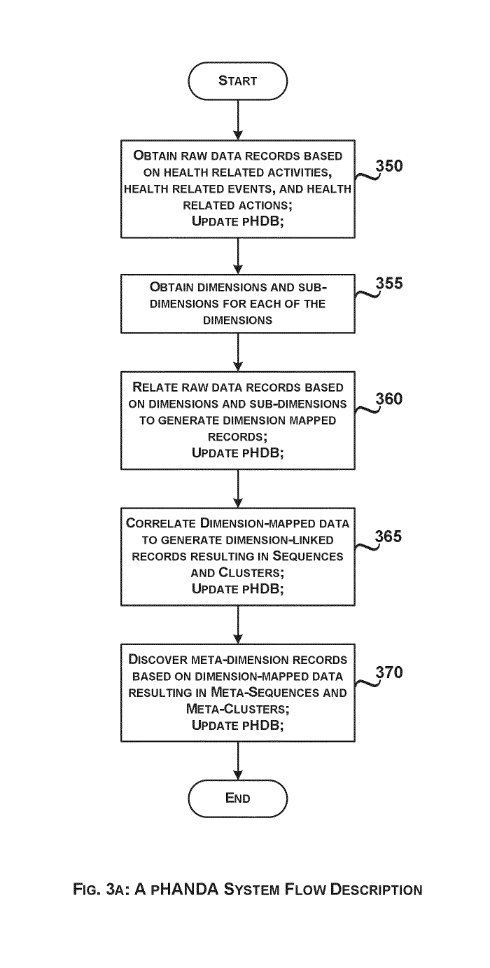

The steps illustrated in FIGS. 3A, 4B, 5, 5A, 5B, 7A, 7B, 7C, 9, 9A and 9B also refer to the corresponding “means” of the system of the present invention for carrying out the relevant steps.

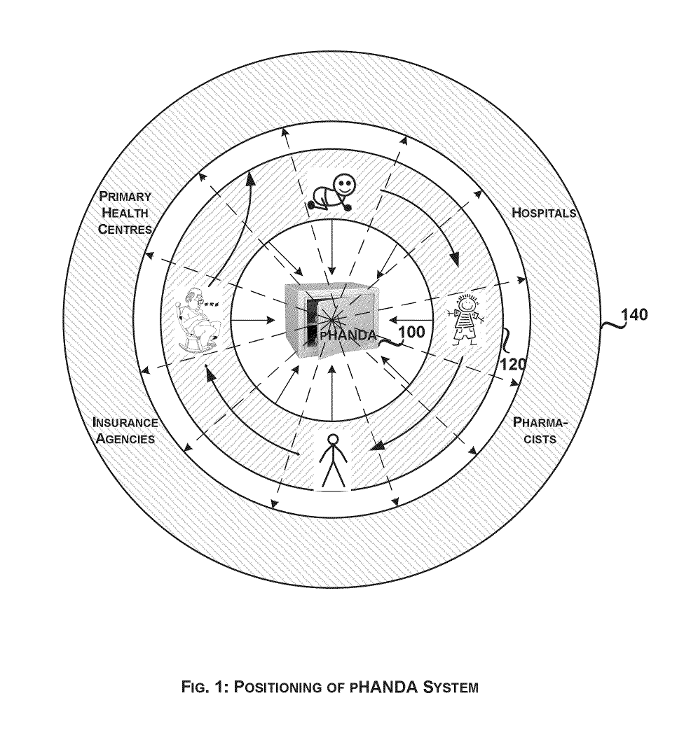

FIG. 1 describes the overall Positioning of pHANDA System. At the heart of the system is the well-protected archived information about the individual (personal/self) (100). The various data that get generated due to the activities of the individual get stored for analysis and distribution purposes. Note that while the archive is distributable, the distribution itself is outside the scope of the present invention: it is supposed that the process of distribution indeed protects the rights of the individual and is based upon the laws of the land. The gathered data is over a period of time and longer this period, more large scale is the extent of analysis and more accurate is the conclusion drawn based on the analysis of the archived data. The figure depicts an ideal situation wherein data gets collected right from birth and systematically afterwards (120). Indeed such a collection provides a digital footprint of the individual highlighting what happened when and why from health point of view. Notice from FIG. 1 that the archived and analyzed data address the needs of the various stakeholders: physicians, nurses, hospital administrators, pharmacists, primary health centers, and insurance agencies (140). At any point in time, these stakeholders are required to query the pHANDA system so that their decisions with respect to the individual are well based.

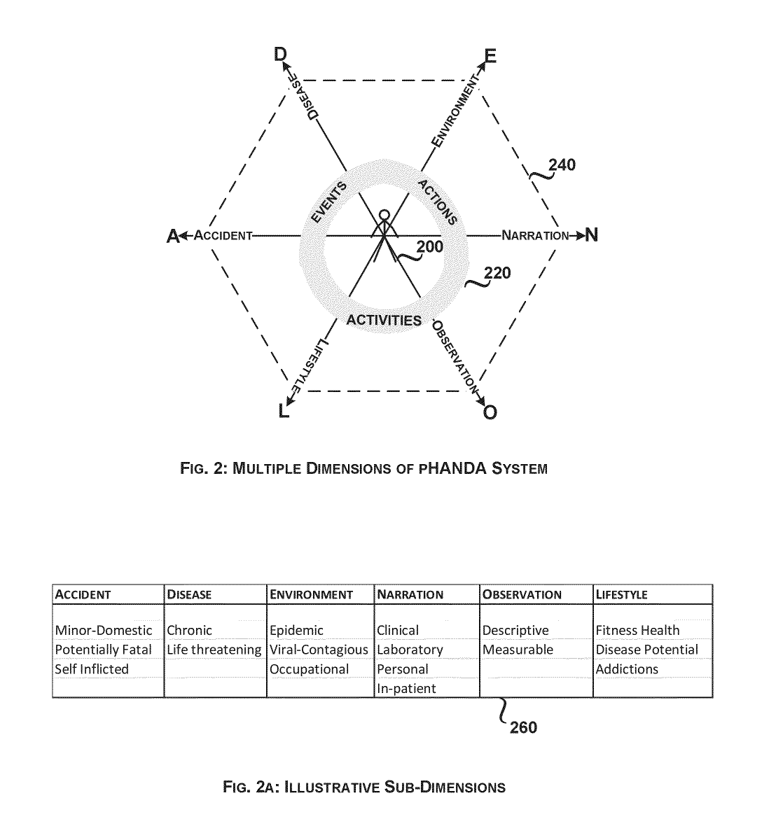

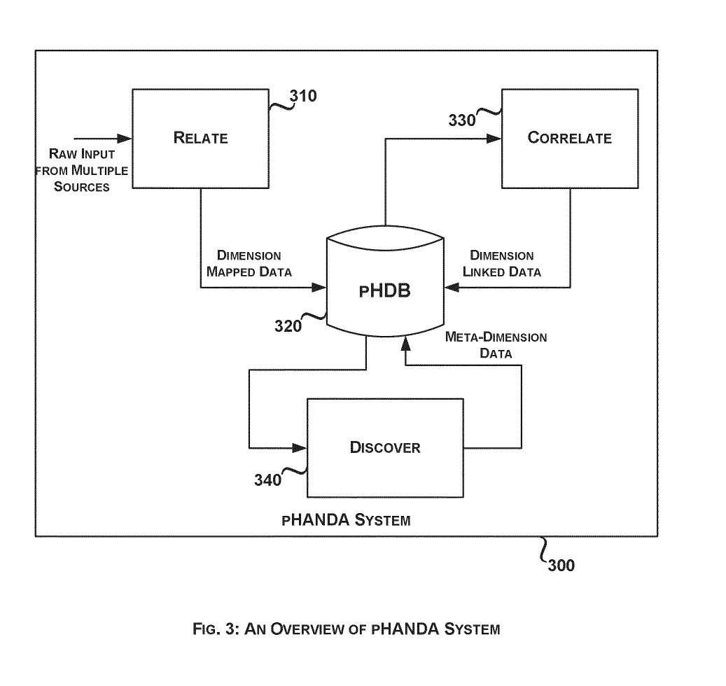

FIG. 2 describes briefly the Multiple Dimensions of pHANDA System. The systematic archiving of the large volume of health related records of the individual needs an approach of categorizing of the data. An individual (200) is involved in a variety of activities leading to actions and events (220). This forms the basic or raw data that need to be archived. The archiving is based on the proposed following six dimensions (240): Accident (A), Disease (D), Environment (E), Narration (N), Observation (0), and Lifestyle (L). These dimensions are expected to be comprehensive and exhaustive in the sense that all of the activities, actions, and the events of and related to the individual get mapped onto one or more of these six dimensions and thereby helping in the process of structuring of raw data. A brief about these dimensions is provided below:

Accident (A) dimension: This dimension captures the data related to accidents met by the individual—minor, domestic, major, road, etc.
Disease (D) dimension: This dimension captures the data related to the various diseases suffered by the individual—simple, chronic, etc.
Environment (E) dimension: This dimension captures the data related to the environment in which the individual lives; note that a systematic analysis of this data is very useful in certain cases for effective diagnosis and also for addressing the well being of the individual.
Narration (N) dimension: This dimension captures data narrated by the individual related to such as pain or sensation.
Observation (O) dimension: This dimension captures data related to such as the various tests performed at labs by technicians.
Lifestyle (L) dimension: This dimension captures data related to the lifestyle related activities of a person such as fitness information.

FIG. 2A provides an illustrative list of Sub-Dimensions. The following provides an illustrative list of sub-dimensions for each of the dimensions (260):

### Dimension: Accident (A)

Sub-dimension examples: Minor-Domestic, Potentially Fatal, and Self Inflicted;

### Dimension: Disease (D)

Sub-dimension examples: Chronic and Life threatening;

### Dimension: Environment (E)

Sub-dimension examples: Epidemic, Viral-Contagious, and Occupational;

### Dimension: Narration (N)

Sub-dimension examples: Clinical, Laboratory, Personal, and In-patient;

### Dimension: Observation (0)

Sub-dimension examples: Descriptive and Measurable;

### Dimension: Lifestyle (L)

Sub-dimension examples: Fitness Health, Disease Potential, and Addictions;

While the six dimensions provide the first level structuring of raw data, the sub-dimensions provide additional structuring of the raw data.

FIG. 3 provides an Overview of pHANDA System. The main objectives of the pHANDA system (300) are to gather as much health related information about an individual as possible, catalog the information in a structured manner, analyze the structured information to derive certain meta-information (analysis), and provide the structured information to the various stakeholders (distribution). The raw data obtained from several sources are analyzed and are mapped one or more of the six dimensions, namely, A, D, E, N, O, and/or L (310). This process is called as “Relate” wherein the raw data records are mapped onto the pre-defined six dimensions. The dimension mapped structured data is called as personal Health Records (pHRs) and are updated onto personal Healthcare database (pHDB) (320). Note raw input from multiple sources is also part of the pHDB. The next step is to analyze the pHRs to establish links across the pHRs in the multiple six dimensions: this process is called as “Correlate” (330) and the dimension linked data are updated onto pHDB. The final step is to analyze the related and correlated pHRs to determine meta-information and this process is called as “Discover” (340) and this meta-dimension data are also updated onto phDB.

FIG. 3A provides a flow description of pHANDA System.

The means for achieving the overall objective of pHANDA system is provided below.

Obtain raw data records based on health related activities, health related events, and health related actions (350); and Update pHDB. Note that these raw data records are input into the system.

Obtain dimensions and sub-dimensions for each of the dimensions (355). Relate raw data records based on dimensions and sub-dimensions to generate dimension mapped records (360); and Update pHDB. Correlate Dimension-mapped data to generate dimension-linked records resulting in Sequences and Clusters (365); and Update pHDB. And finally, Discover meta-dimension records based on dimension-mapped data resulting in Meta-Sequences and Meta-Clusters (370); and Update pHDB.

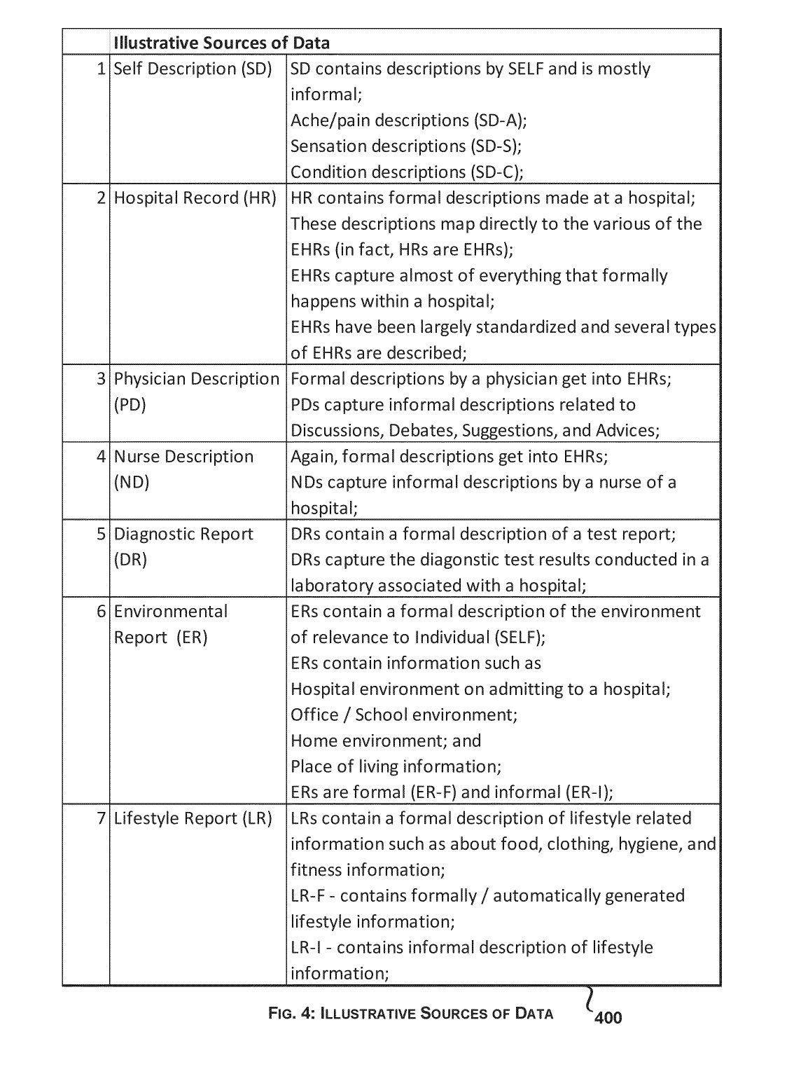

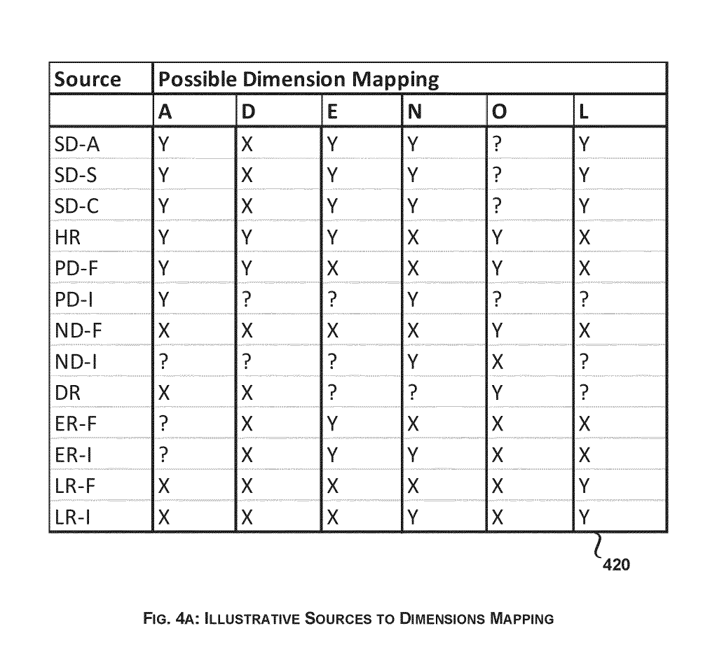

FIG. 4 provides an illustrative list of Sources of raw Data. The table (400) depicts the means for obtaining of data related to seven illustrative raw sources:

Illustrative Sources of Data

### 1 Self Description (SD)

SD contains descriptions by SELF and is mostly informal;
Ache/pain descriptions (SD-A);
Sensation descriptions (SD-S);
Condition descriptions (SD-C);

### 2 Hospital Record (HR)

HR contains formal descriptions made at a hospital;
These descriptions map directly to the various of the Electronic Health Records (EHRs) (in fact, HRs are EHRs);
EHRs capture almost of everything that formally happens within a hospital;
EHRs have been largely standardized and several types of EHRs are described;

### 3 Physician Description (PD)

Formal descriptions by a physician get into EHRs;
PDs capture informal descriptions related to Discussions, Debates, Suggestions, and Advices;

### 4 Nurse Description (ND)

Again, formal descriptions get into EHRs;
NDs capture informal descriptions by a nurse of a hospital;

### 5 Diagnostic Report (DR)

DRs contain a formal description of a test report;
DRs capture the diagonstic test results conducted in a laboratory associated with a hospital;

### 6 Environmental Report (ER)

ERs contain a formal description of the environment of relevance to Individual (SELF);
ERs contain information such as
Hospital environment on admitting to a hospital;
Office/School environment;
Home environment; and
Place of living information;
ERs are formal (ER-F) and informal (ER-I);

### 7 Lifestyle Report (LR)

LRs contain a formal description of lifestyle related information such as about food, clothing, hygiene, and fitness information;
LR-F—contains formally/automatically generation lifestyle information;
LR-I—contains informal description of lifestyle information;

FIG. 4A provides an illustrative Dimension Mapping. The table (420) depicts an illustrative mapping of sources of data to the various dimensions. Note that “Y” indicates a sure map while “X” indicates that mapping is impossible. Further, a “?” indicates a possibility of a mapping. This table gets used in Relate to effectively map the vague, ambiguous raw data to one or more of the six dimensions.

### Source Possible Dimension Mapping:

### SD-A: A(Y), D(X), E(Y), N(Y), O(?), and L(Y);

### SD-S: A(Y), D(X), E(Y), N(Y), O(?), and L(Y);

### SD-C: A(Y), D(X), E(Y), N(Y), O(?), and L(Y);

### HR: A(Y), D(Y), E(X), N(X), O(Y), and L(X);

### PD-F: A(Y), D(Y), E(X), N(X), O(Y), and L(X);

### PD-I: A(Y), D(?), E(?), N(Y), O(?), and L(?);

### ND-F: A(X), D(X), E(X), N(X), O(Y), and L(X);

### ND-I: A(?), D(?), E(?), N(Y), O(X), and L(?);

### DR: A(X), D(X), E(?), N(?), O(Y), and L(?);

### ER-F: A(?), D(X), E(Y), N(X), O(X), and L(X);

### ER-I: A(?), D(X), E(Y), N(Y), O(X), and L(X);

### LR-F: A(X), D(X), E(X), N(X), O(X), and L(Y);

### LR-I: A(X), D(X), E(X), N(Y), O(X), and L(Y);

FIG. 4B depicts an illustrative Flow of Data Acquisition.

The means for obtaining a plurality of raw data records is provided below.

Obtain a self-description data record based on health related activities, health related events, and health related actions (450); and Update pHDB. Note that such self-description records are input into the system.

Obtain a hospital data record based on health related activities, health related events, and health related actions (455); and Update pHDB.

Obtain a physician description data record based on health related activities, health related events, and health related actions (460); and Update pHDB.

Obtain a nurse description data record based on health related activities, health related events, and health related actions (465); and Update pHDB.

Obtain a diagnostic description data record based on health related activities, health related events, and health related actions (470); and Update pHDB.

Obtain an environmental description data record based on health related activities, health related events, and health related actions (475); and Update pHDB.

Obtain a lifestyle description data record based on health related activities, health related events, and health related actions (480); and Update pHDB.

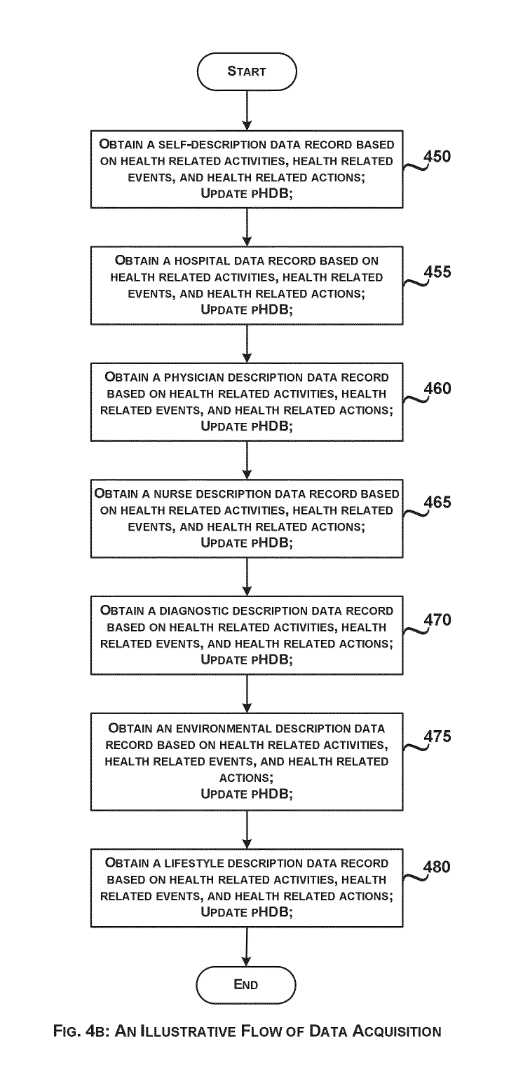

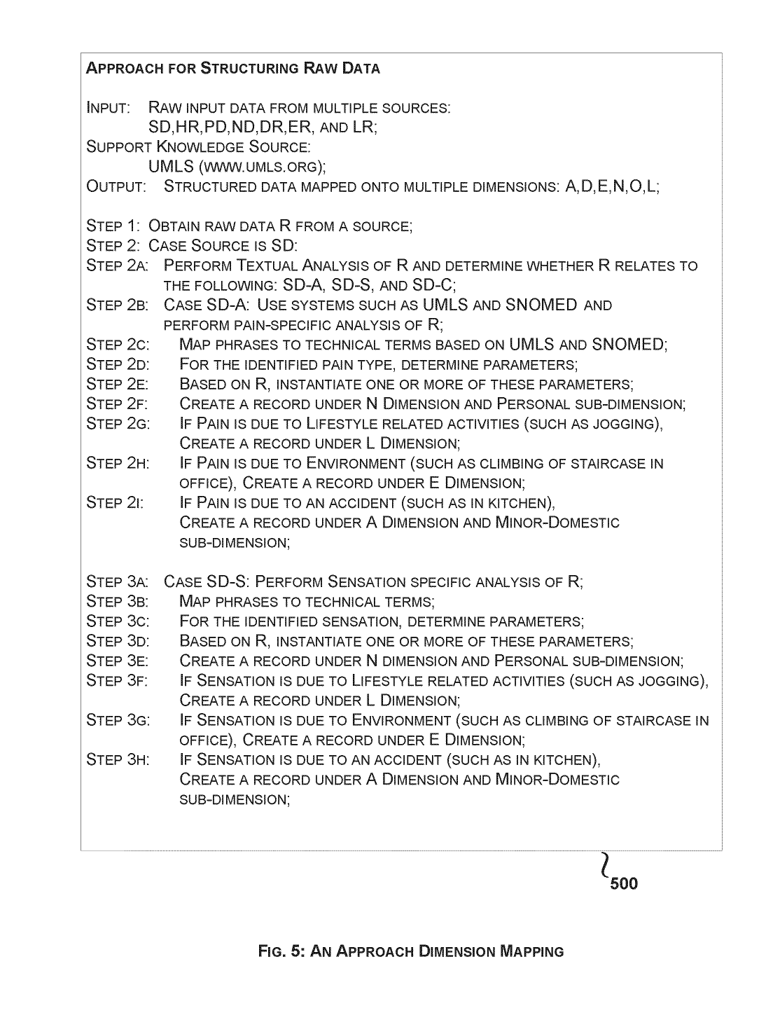

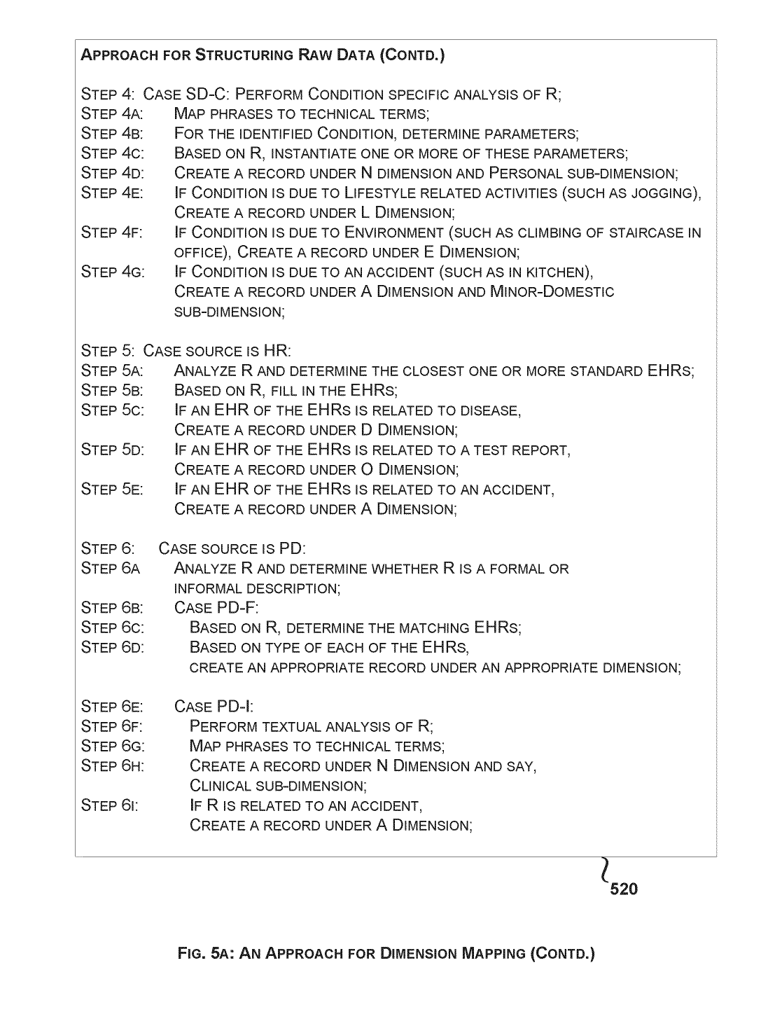

FIG. 5 provides an Approach for Dimension Mapping.

### Means for (“Relating”) an Approach for Structuring Raw Data (500):

Input: Raw input data from multiple sources:
SD, HR, PD, ND, DR, ER, and LR;

### Support Knowledge Source:

UMLS (www.umls.org);
   Output: Structured data mapped onto multiple dimensions: A, D, E, N, O, L;
Step 1: Obtain raw data R from a source;
Step 2: Case Source is SD:
Step 2a: Perform Textual Analysis of R and determine whether R relates to the following:
   SD-A, SD-S, and SD-C;
Step 2b: Case SD-A: Use systems such as UMLS and SNOMED and
   perform pain-specific analysis of R;
Step 2c: Map phrases to technical terms based on UMLS and SNOMED;
Step 2d: For the identified pain type, determine parameters;
Step 2e: Based on R, instantiate one or more of these parameters;
Step 2f: Create a record under N Dimension and Personal sub-dimension;
Step 2g: If Pain is due to Lifestyle related activities (such as jogging),
   Create a record under L Dimension;
Step 2h: If Pain is due to Environment (such as climbing of staircase in office),
   Create a record under E Dimension;
Step 2i: If Pain is due to an accident (such as in kitchen),
   Create a record under A Dimension and Minor-Domestic sub-dimension;
Step 3a: Case SD-S: Perform Sensation specific analysis of R;
Step 3b: Map phrases to technical terms;
Step 3c: For the identified sensation, determine parameters;
Step 3d: Based on R, instantiate one or more of these parameters;
Step 3e: Create a record under N dimension and Personal sub-dimension;
Step 3f: If Sensation is due to Lifestyle related activities (such as jogging),
   Create a record under L Dimension;
Step 3g: If Sensation is due to Environment (such as climbing of staircase in office),
   Create a record under E Dimension;
Step 3h: If Sensation is due to an accident (such as in kitchen),
   Create a record under A Dimension and Minor-Domestic sub-dimension;

FIG. 5A provides additional information related to the Approach for Dimension Mapping.

### Means (“Relating”) for an Approach for Structuring Raw Data (Contd.) (520):

Step 4: Case SD-C: Perform Condition specific analysis of R;
Step 4a: Map phrases to technical terms;
Step 4b: For the identified Condition, determine parameters;
Step 4c: Based on R, instantiate one or more of these parameters;
Step 4d: Create a record under N dimension and Personal sub-dimension;
Step 4e: If Condition is due to Lifestyle related activities (such as jogging),
   Create a record under L Dimension;
Step 4f: If Condition is due to Environment (such as climbing of staircase in office),
   Create a record under E Dimension;
Step 4g: If Condition is due to an accident (such as in kitchen),
   Create a record under A Dimension and Minor-Domestic sub-dimension;
Step 5: Case source is HR:
Step 5a: Analyze R and determine the closest one or more standard EHRs;
Step 5b: Based on R, fill in the EHRs;
Step 5c: If an EHR of the EHRs is related to disease,
   Create a record under D Dimension;
Step 5d: If an EHR of the EHRs is related to a test report,
   Create a record under O Dimension;
Step 5e: If an EHR of the EHRs is related to an accident,
   Create a record under A Dimension;
Step 6: Case source is PD:
Step 6a Analyze R and determine whether R is a formal or informal description;
Step 6b: Case PD-F:
Step 6c: Based on R, determine the matching EHRs;
Step 6d: Based on type of each of the EHRs,
   Create an appropriate record under an appropriate dimension;
Step 6e: Case PD-I:
Step 6f: Perform textual analysis of R;
Step 6g: Map phrases to technical terms;
Step 6h: Create a record under N Dimension and say, Clinical sub-dimension;
Step 6i: If R is related to an accident,
   Create a record under A Dimension;

FIG. 5B provides some more information related to the Approach for Dimension Mapping.

### Means (“Relating”) for an Approach for Structuring Raw Data (Contd.) (540):

Step 7: Case source is ND:
Step 7a Analyze R and determine whether R is a formal or informal description;
Step 7b: Case ND-F:
Step 7c: Based on R, determine the matching EHRs;
Step 7d: Based on type of each of the EHRs,
   Create an appropriate record under an appropriate dimension,
   say, under O Dimension;
Step 7e: Case ND-I:
Step 7f: Perform textual analysis of R;
Step 7g: Map phrases to technical terms;
Step 7h: Create a record under N Dimension and say, In-Patient sub-dimension;
Step 8: Case source is DR:
Step 8a: Based on R, determine the matching EHRs;
Step 8b: Based on type of each of the EHRs,
   Create an appropriate record under an appropriate dimension,
   say, under O Dimension;
Step 9: Case source is ER:
Step 9a Analyze R and determine whether R is a formal or informal description;
Step 9b: Case ER-F:
Step 9c: Based on R, determine the matching EHRs;
Step 9d: Based on type of each of the EHRs,
   Create an appropriate record under an appropriate dimension,
   say, under E Dimension;
Step 9e: Case ER-I:
Step 9f: Perform textual analysis of R;
Step 9g: Map phrases to technical terms;
Step 9h: Create a record under N Dimension;
Step 10: Case source is LR:
Step 10a Analyze R and determine whether R is a formal or informal description;
Step 10b: Case LR-F:
Step 10c: Based on R, determine the matching EHRs;
Step 10d: Based on type of each of the EHRs,
   Create an appropriate record under an appropriate dimension,
   say, under L Dimension;
Step 10e: Case LR-I:
Step 10f: Perform textual analysis of R;
Step 10g: Map phrases to technical terms;
Step 10h: Create a record under N Dimension;
Step 11: END.

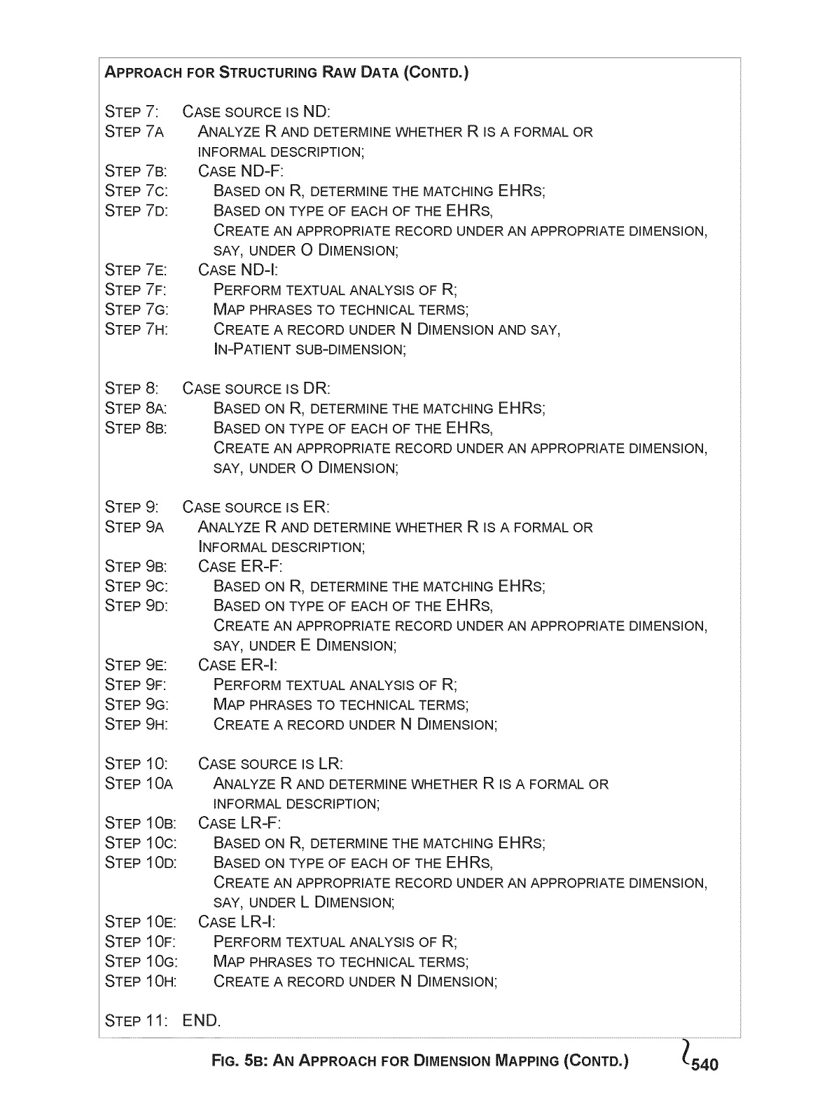

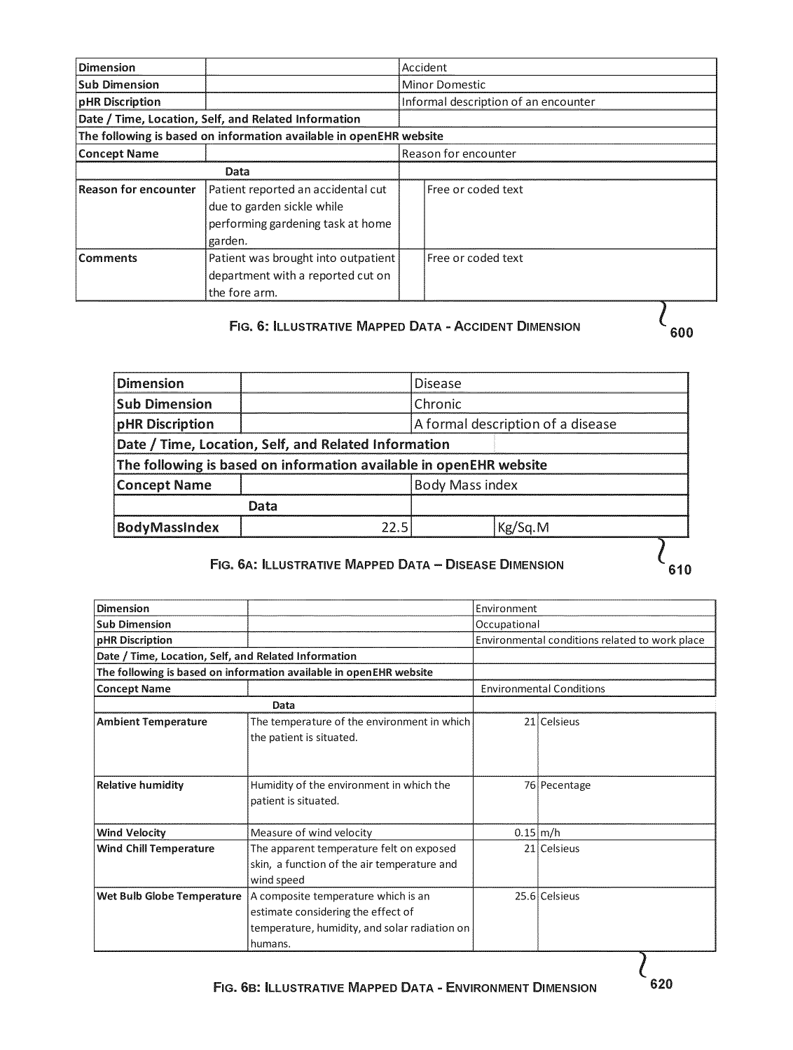

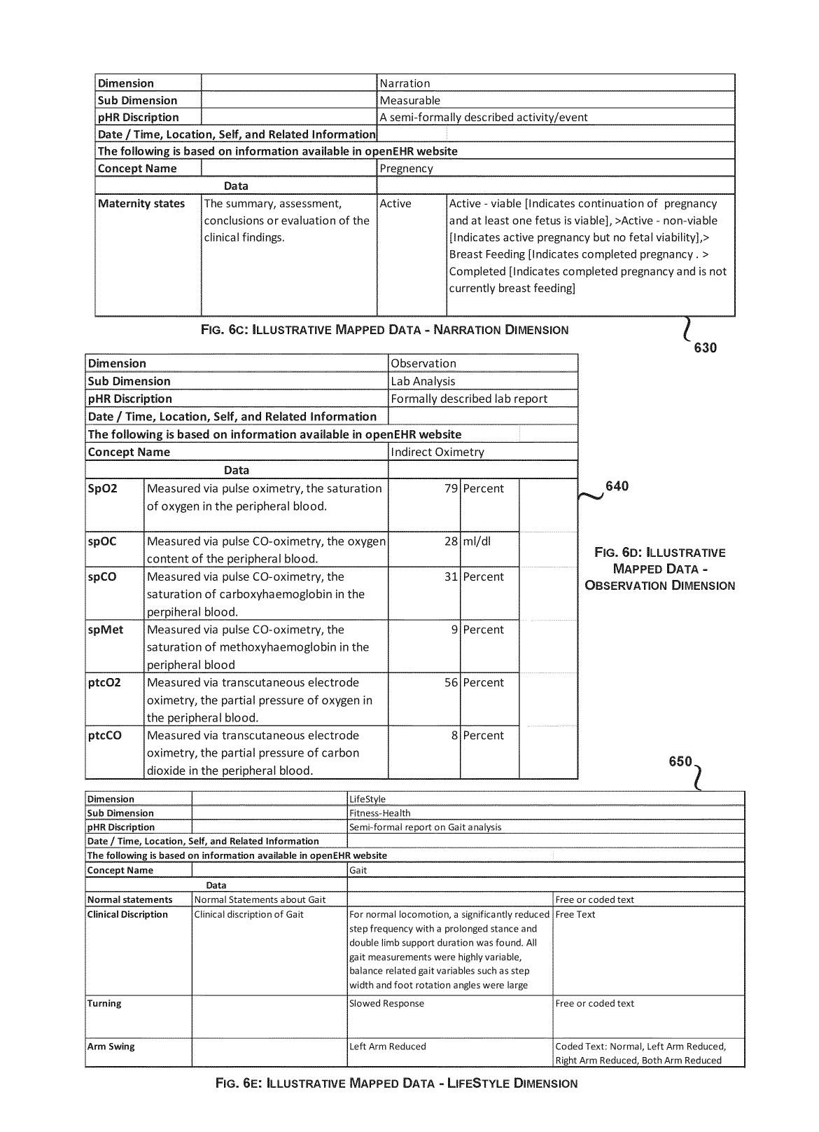

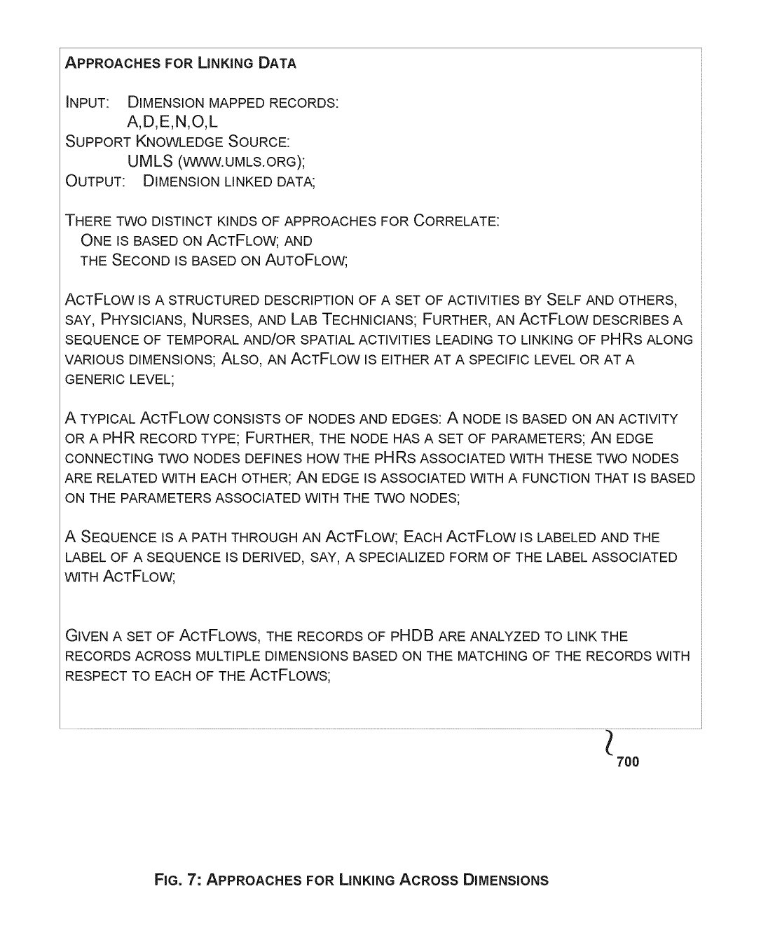

FIG. 6 provides an illustrative Mapped Data—Accident Dimension. The raw source data is analyzed to fill in the various fields of the A dimension pHR (600). Note that apart from the specific data, the pHR also contains the general data such as date/time, location, information about self, and other related information.

FIG. 6A provides an illustrative Mapped Data—Disease Dimension. The raw source data is analyzed to fill in the various fields of D dimension pHR (610).

FIG. 6B provides an illustrative Mapped Data—Environment Dimension. The raw source data is analyzed to fill in the various fields of E dimension pHR (620).

FIG. 6C provides an illustrative Mapped Data—Narration Dimension. The raw source data is analyzed to fill in the various fields of D dimension pHR (630).

FIG. 6D provides an illustrative Mapped Data—Observation Dimension. The raw source data is analyzed to fill in the various fields of O dimension pHR (640).

FIG. 6E provides an illustrative Mapped Data—LifeStyle Dimension. The raw source data is analyzed to fill in the various fields of L dimension pHR (650).

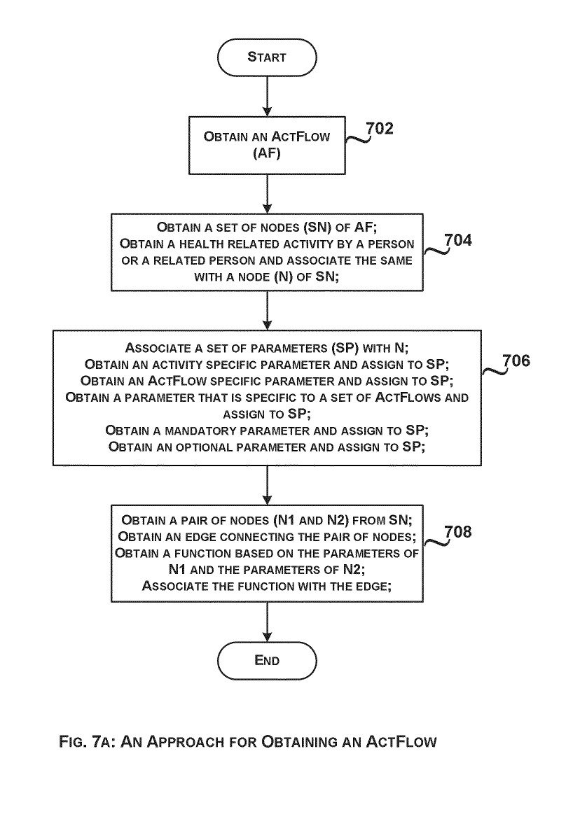

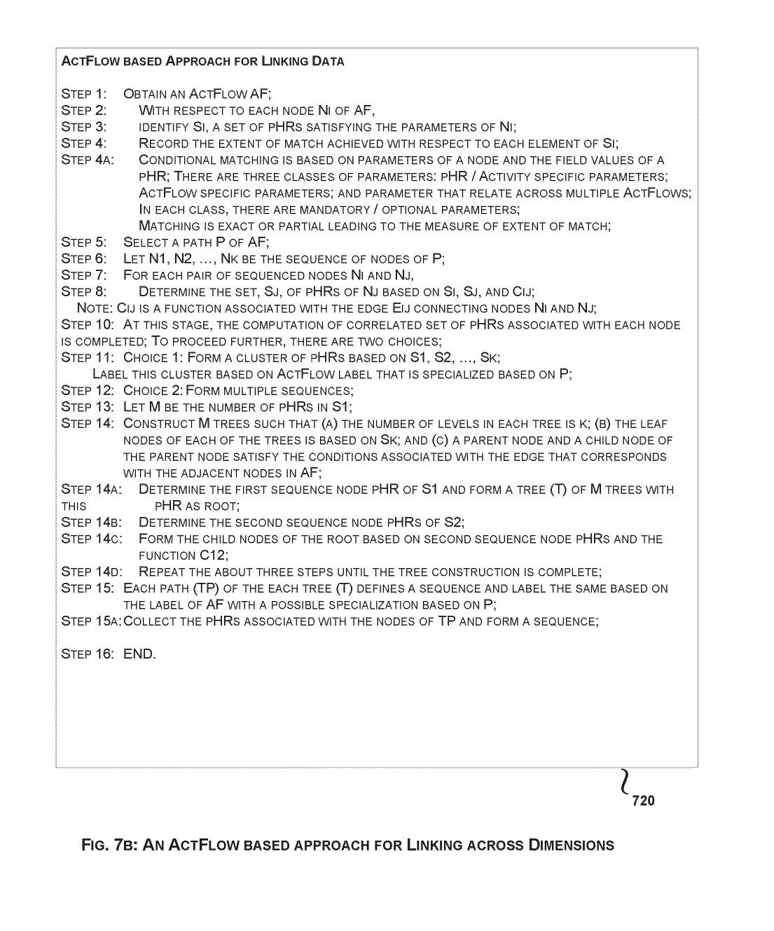

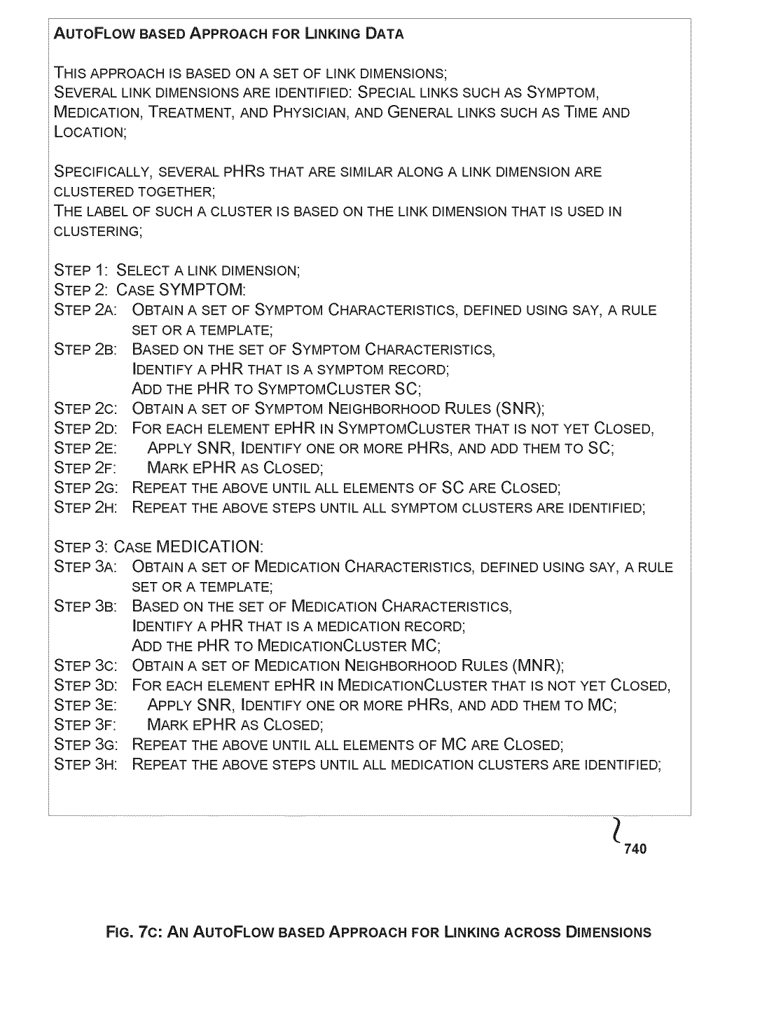

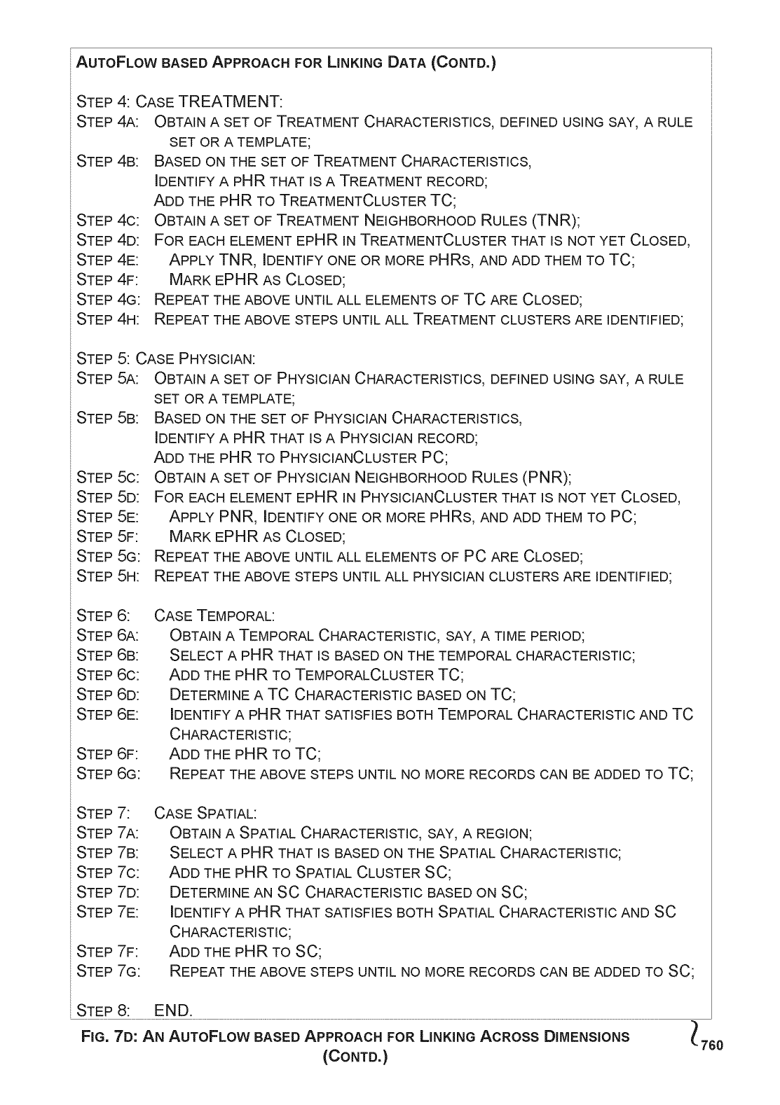

FIG. 7 depicts approaches for Linking across Dimensions.

### Means for (“Correlating”) Approaches for Linking Data (700):

Input: Dimension mapped records:
A, D, E, N, O, L

### Support Knowledge Source:

UMLS (www.umls.org);
   Output: Dimension linked data;

There two distinct kinds of approaches for Correlate:
One is based on ActFlow; and
the Second is based on AutoFlow;

ActFlow is a structured description of a set of activities by Self and others, say, Physicians, Nurses, and Lab Technicians; Further, an ActFlow describes a sequence of temporal and/or spatial activities leading to linking of pHRs along various dimensions; Also, an ActFlow is either at a specific level or at a generic level;

A typical ActFlow consists of nodes and edges: A node is based on an activity or a pHR record type; Further, the node has a set of parameters; An edge connecting two nodes defines how the pHRs associated with these two nodes are related with each other; An edge is associated with a function that is based on the parameters associated with the two nodes;

A Sequence is a path through an ActFlow; Each ActFlow is labeled and the label of a sequence is derived, say, a specialized form of the label associated with ActFlow;

Given a set of ActFlows, the records of pHDB are analyzed to link the records across multiple dimensions based on the matching of the records with respect to each of the ActFlows;

FIG. 7A provides an approach for obtaining an ActFlow.

The means for obtaining of an actflow is provided below.

Obtain an ActFlow (AF) (720). Obtain a set of nodes (SN) of AF (704); and obtain a health related activity by a person or a related person and associate the same with a node (N) of SN. Associate a set of parameters (SP) with N (706); Obtain an activity specific parameter and assign to SP; Obtain an ActFlow specific parameter and assign to SP; Obtain a parameter that is specific to a set of ActFlows and assign to SP; Obtain a mandatory parameter and assign to SP; and Obtain an optional parameter and assign to SP. Obtain a pair of nodes (N1 and N2) from SN (708); Obtain an edge connecting the pair of nodes; Obtain a function based on the parameters of N1 and the parameters of N2; and associate the function with the edge.

FIG. 7B provides an ActFlow based approach for Linking across Dimensions.

### Means for (“Correlating”) ActFlow Based Approach for Linking Data (720):

Step 1: Obtain an ActFlow AF;
Step 2: With respect to each node Ni of AF,
Step 3: identify Si, a set of pHRs satisfying the parameters of Ni;
Step 4: Record the extent of match achieved with respect to each element of Si;
Step 4a: Conditional matching is based on parameters of a node and the field values of a pHR;
   There are three classes of parameters: pHR/Activity specific parameters; ActFlow specific parameters; and parameter that relate across multiple ActFlows;
   In each class, there are mandatory/optional parameters; Matching is exact or partial leading to the measure of extent of match;
Step 5: Select a path P of AF;
Step 6: Let N1, N2, . . . , Nk be the sequence of nodes of P;
Step 7: For each pair of sequenced nodes Ni and Nj, Step 8: Determine the set, Sj, of pHRs of Nj based on Si, Sj, and Cij;
   Note: Cij is a function associated with the edge Eij connecting nodes Ni and Nj;
Step 10: At this stage, the computation of correlated set of pHRs associated with each node is completed; To proceed further, there are two choices;
Step 11: Choice 1: Form a cluster of pHRs based on S1, S2, . . . , Sk; Label this cluster based on ActFlow label that is specialized based on P;
Step 12: Choice 2: Form multiple sequences;
Step 13: Let M be the number of pHRs in Si;
Step 14: Construct M trees such that (a) the number of levels in each tree is k; (b) the leaf nodes of each of the trees is based on Sk; and (c) a parent node and a child node of the parent node satisfy the conditions associated with the edge that corresponds with the adjacent nodes in AF;
Step 14a: Determine the first sequence node pHR of S1 and form a tree (T) of M trees with this pHR as root;
Step 14b: Determine the second sequence node pHRs of 52;
Step 14c: Form the child nodes of the root based on second sequence node pHRs and the function C12;
Step 14d: Repeat the about three steps until the tree construction is complete;
Step 15: Each path (TP) of the each tree (T) defines a sequence and label the same based on the label of AF with a possible specialization based on P;
Step 15a: Collect the pHRs associated with the nodes of TP and form a sequence;
Step 16: END.

FIG. 7C provides an AutoFlow based Approach for Linking across Dimensions.

### Means (“Correlating”) for AutoFlow Based Approach for Linking Data (740):

This approach is based on a set of link dimensions;

Several link dimensions are identified: Special links such as Symptom, Medication, Treatment, and Physician, and General links such as Time and Location;

Specifically, several pHRs that are similar along a link dimension are clustered together;

The label of such a cluster is based on the link dimension that is used in clustering;
Step 1: Select a link dimension;
Step 2: Case SYMPTOM:
Step 2a: Obtain a set of Symptom Characteristics, defined using say, a rule set or a template;
Step 2b: Based on the set of Symptom Characteristics,
   Identify a pHR that is a symptom record;
   Add the pHR to SymptomCluster SC;
Step 2c: Obtain a set of Symptom Neighborhood Rules (SNR);
Step 2d: For each element epHR in SymptomCluster that is not yet Closed,
Step 2e: Apply SNR, Identify one or more pHRs, and add them to SC;
   Note that, in a particular embodiment, each of the rules of the set of Symptom Neighborhood Rules relates symptom characteristics thereby enabling the identification of those pHRs that are a neighbor of (“nearer” to) an epHR based on the symptom characteristics associated with the pHRs and the epHR, and hence, those pHRs that satisfy SNR qualify to be in the same cluster as that of the ePHR.
Step 2f: Mark ePHR as Closed;
Step 2g: Repeat the above until all elements of SC are Closed;
Step 2h: Repeat the above steps until all symptom clusters are identified;
Step 3: Case MEDICATION:
Step 3a: Obtain a set of Medication Characteristics, defined using say, a rule set or a template;
Step 3b: Based on the set of Medication Characteristics,
   Identify a pHR that is a medication record;
   Add the pHR to MedicationCluster MC;
Step 3c: Obtain a set of Medication Neighborhood Rules (MNR);
Step 3d: For each element epHR in MedicationCluster that is not yet Closed,
Step 3e: Apply SNR, Identify one or more pHRs, and add them to MC;
Step 3f: Mark ePHR as Closed;
Step 3g: Repeat the above until all elements of MC are Closed;
Step 3h: Repeat the above steps until all medication clusters are identified;

FIG. 7d provides additional information related to the AutoFlow based Approach for Linking across Dimensions.

### Means (“Correlating”) for AutoFlow Based Approach for Linking Data (Contd.) (760):

Step 4: Case TREATMENT:
Step 4a: Obtain a set of Treatment Characteristics, defined using say, a rule set or a template;
Step 4b: Based on the set of Treatment Characteristics,
   Identify a pHR that is a Treatment record;
   Add the pHR to TreatmentCluster TC;
Step 4c: Obtain a set of Treatment Neighborhood Rules (TNR);
Step 4d: For each element epHR in TreatmentCluster that is not yet Closed,
Step 4e: Apply TNR, Identify one or more pHRs, and add them to TC;
Step 4f: Mark ePHR as Closed;
Step 4g: Repeat the above until all elements of TC are Closed;
Step 4h: Repeat the above steps until all Treatment clusters are identified;
Step 5: Case Physician:
Step 5a: Obtain a set of Physician Characteristics, defined using say, a rule set or a template;
Step 5b: Based on the set of Physician Characteristics,
   Identify a pHR that is a Physician record;
   Add the pHR to PhysicianCluster PC;
Step 5c: Obtain a set of Physician Neighborhood Rules (PNR);
Step 5d: For each element epHR in PhysicianCluster that is not yet Closed,
Step 5e: Apply PNR, Identify one or more pHRs, and add them to PC;
Step 5f: Mark ePHR as Closed;
Step 5g: Repeat the above until all elements of PC are Closed;
Step 5h: Repeat the above steps until all physician clusters are identified;
Step 6: Case Temporal:
Step 6a: Obtain a Temporal Characteristic, say, a time period;
Step 6b: Select a pHR that is based on the temporal characteristic;
Step 6c: Add the pHR to TemporalCluster TC;
Step 6d: Determine a TC Characteristic based on TC;
Step 6e: Identify a pHR that satisfies both Temporal Characteristic and TC Characteristic;
Step 6f: Add the pHR to TC;
Step 6g: Repeat the above steps until no more records can be added to TC;
Step 7: Case Spatial:
Step 7a: Obtain a Spatial Characteristic, say, a region;
Step 7b: Select a pHR that is based on the Spatial Characteristic;
Step 7c: Add the pHR to Spatial Cluster SC;
Step 7d: Determine an SC Characteristic based on SC;
Step 7e: Identify a pHR that satisfies both Spatial Characteristic and SC Characteristic;
Step 7f: Add the pHR to SC;
Step 7g: Repeat the above steps until no more records can be added to SC;
Step 8: END.

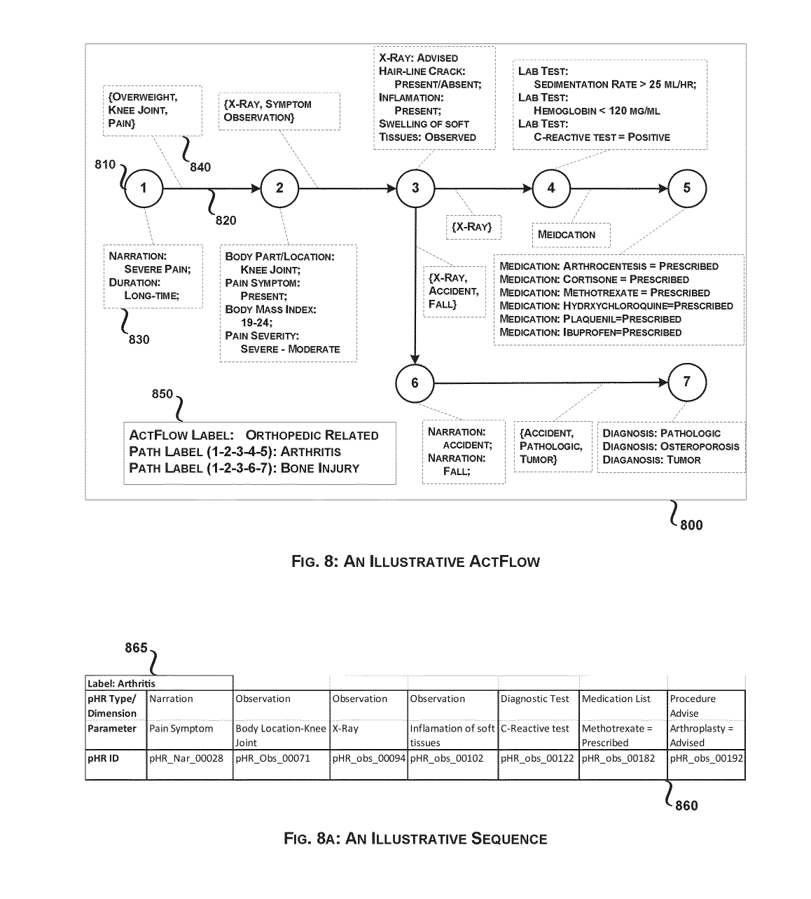

FIG. 8 depicts an illustrative ActFlow (800). Observe that an actflow consists of a set of nodes (node 1 (810), node 2, node 3, node 4, node 5, node 6, and node 7) and interconnected by edges as appropriate (edge 1-2 (820)). Each node is associated with a set of parameters (830) and similarly, each edge is associated with a set of parameters (840). Further, each actflow is associated with a label and where appropriate, select paths of an actflow are provided with a label (850).

FIG. 8A depicts an illustrative Sequence. Note that the sequence (860) is a sequence of pHRs that is based on a path of an actflow and satisfies that parameters associated with nodes and edges of the path. Furthermore, where appropriate, the sequence is provided with a label (865).

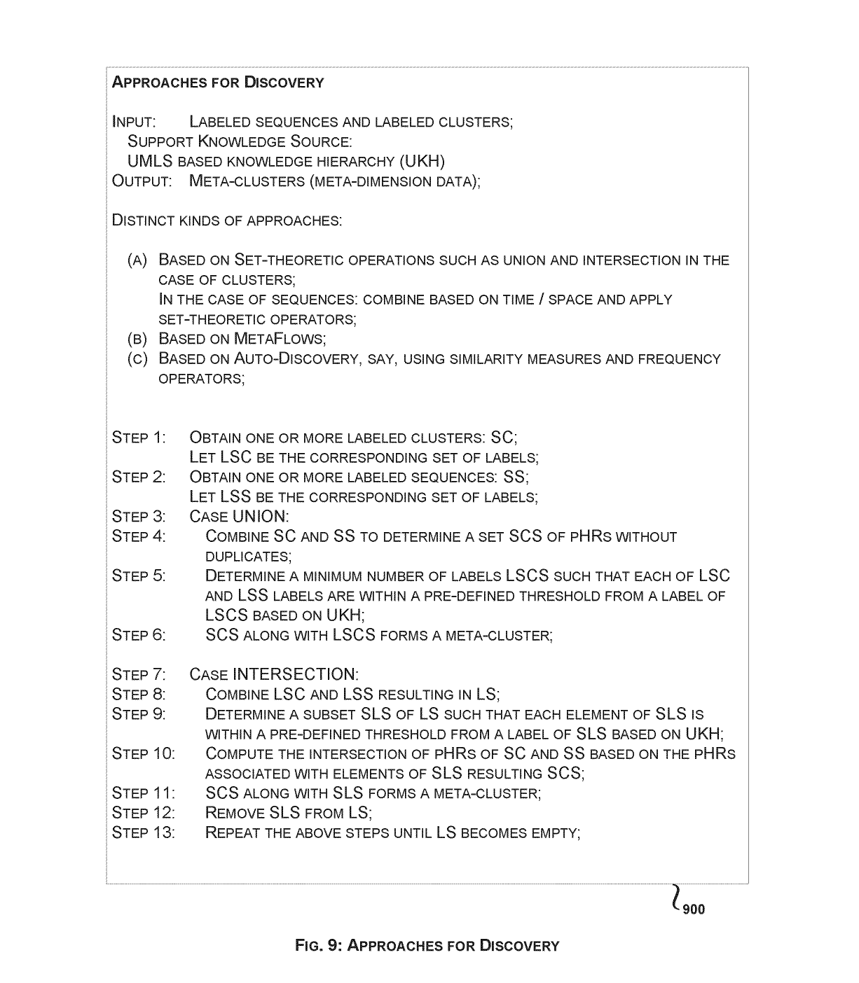

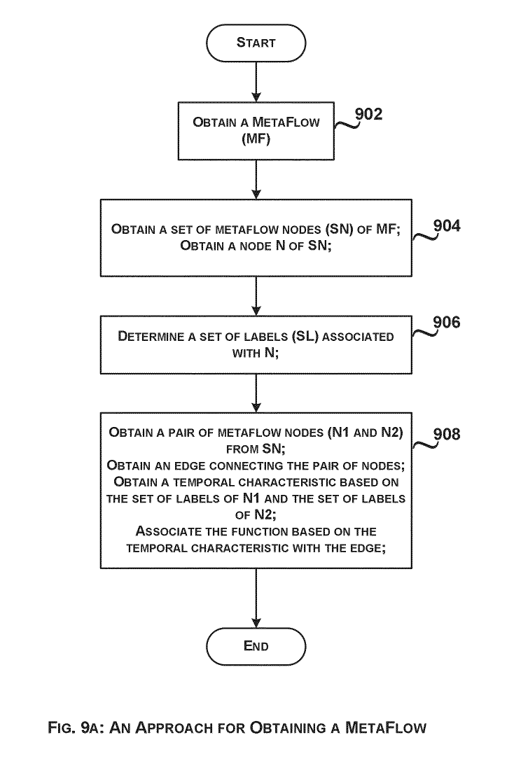

FIG. 9 describes an approach for Discovery.

### Means (“Discovering”) for Approaches for Discovery (900):

Input: Labeled sequences and labeled clusters;
Support Knowledge Source:
UMLS based knowledge hierarchy (UKH)
   Output: Meta-clusters (meta-dimension data);

### Distinct Kinds of Approaches:

(a) Based on Set-theoretic operations such as union and intersection in the case of clusters; in the case of sequences: combine based on time/space and apply set-theoretic operators;
(b) Based on MetaFlows;
(c) Based on Auto-Discovery, say, using similarity measures and frequency operators;
Step 1: Obtain one or more labeled clusters: SC;
   Let LSC be the corresponding set of labels;
Step 2: Obtain one or more labeled sequences: SS;
   Let LSS be the corresponding set of labels;
Step 3: Case UNION:
Step 4: Combine SC and SS to determine a set SCS of pHRs without duplicates;
Step 5: Determine a minimum number of labels LSCS such that each of LSC and LSS labels are within a pre-defined threshold from a label of LSCS based on UKH;
Step 6: SCS along with LSCS forms a meta-cluster;
Step 7: Case INTERSECTION:
Step 8: Combine LSC and LSS resulting in LS;
Step 9: Determine a subset SS of IS such that each element of SLS is within a pre-defined threshold from a label of SLS based on UKH;
Step 10: Compute the intersection of pHRs of SC and SS based on the pHRs associated with elements of SLS resulting SCS;
Step 11: SCS along with SLS forms a meta-cluster;
Step 12: Remove SLS from LS;
Step 13: Repeat the above steps until IS becomes empty;

FIG. 9A provides an approach for obtaining a MetaFlow.

The means for obtaining a metaflow is provided below.

Obtain a MetaFlow (MF) (902). Obtain a set of metaflow nodes (SN) of MF (904); and Obtain a node N of SN. Determine a set of labels (SL) associated with N (906). Obtain a pair of metaflow nodes (N1 and N2) from SN (908); Obtain an edge connecting the pair of nodes; Obtain a temporal characteristic based on the set of labels of Ni and the set of labels of N2; and Associate the function based on the temporal characteristic with the edge.

FIG. 9B describes additional approaches for Discovery.

### Means (“Discovering”) for Approaches for Discovery (Contd.) (920):

MetaFlow defines a meta-sequence of sequences;
Each meta-node of a MetaFlow defines a label or a set of labels;
The edge of a metaFlow relates to connecting labels (meta-nodes) temporally;
The MetaFlow also defines a set of rules for relating the associated pHRs;
Step 14: Obtain a metaFlow MF;
Step 15: Determine a path P of MF;
Step 16: For each meta-node in P,
Step 17: Obtain the associated set SL of Labels;
Step 18: Determine the set of pHRs wherein, each of the pHRs is associated with a label of SL;
Step 19: Add this set of pHRs to MetaSet;
Note: MetaSet is a set of sets;
Step 20: Obtain RuleSet associated with MF;
Step 21: Apply RuleSet on MetaSet to determine Meta-Cluster;
Note: Meta-Cluster defines a meta-sequence based on MF;
Step 22: Associate the label of MF as the label of Meta-Cluster;

### Auto Discovery:

Determines meta-sequences/meta-clusters based on a set of unsupervised techniques;
Step 23: Obtain a sequence or a cluster CS (seed);
Step 24: Obtain the label LCS corresponding with CS;
Step 25: Determine sequences and clusters, SCS, that are similar to CS based on a similarity measure, LCS, UKH, and a pre-defined threshold;
Step 26: Combine SCS to determine Meta-Cluster;
Step 27: Based on the labels associated with the elements of Meta-Cluster, determine the label for Meta-Cluster;
Step 28: END.

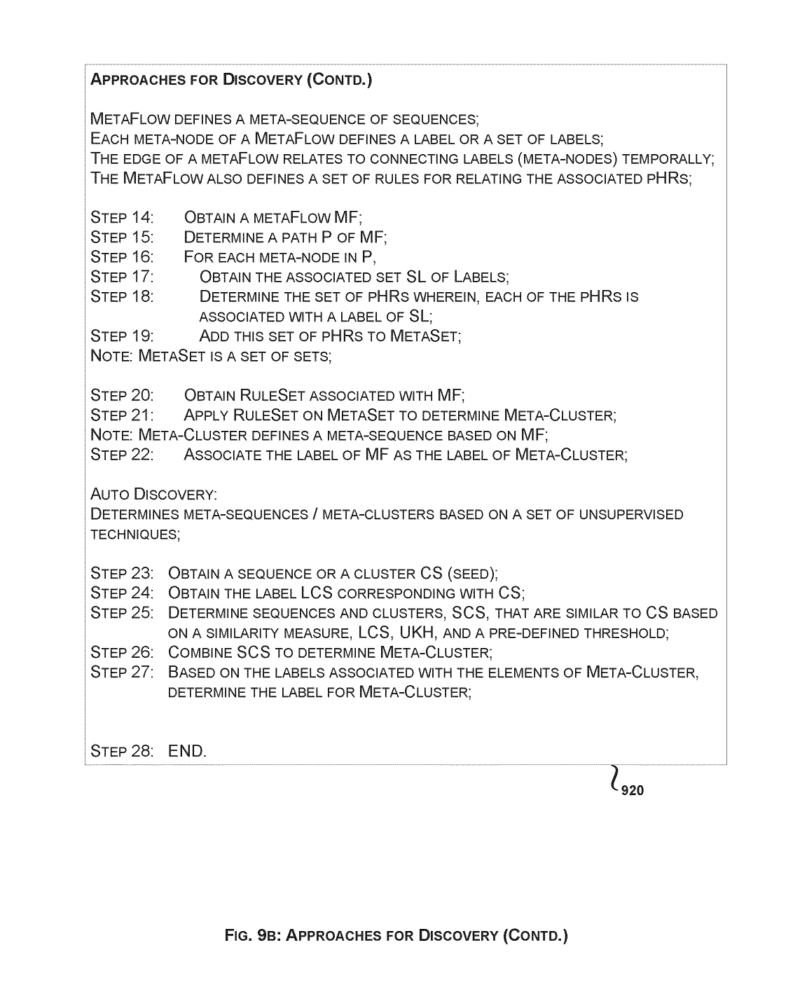

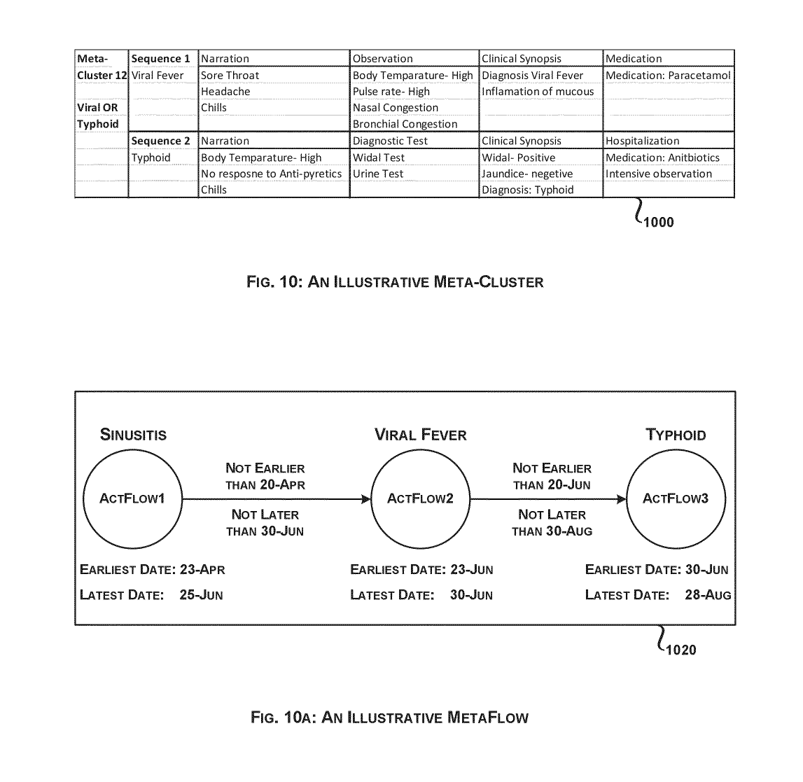

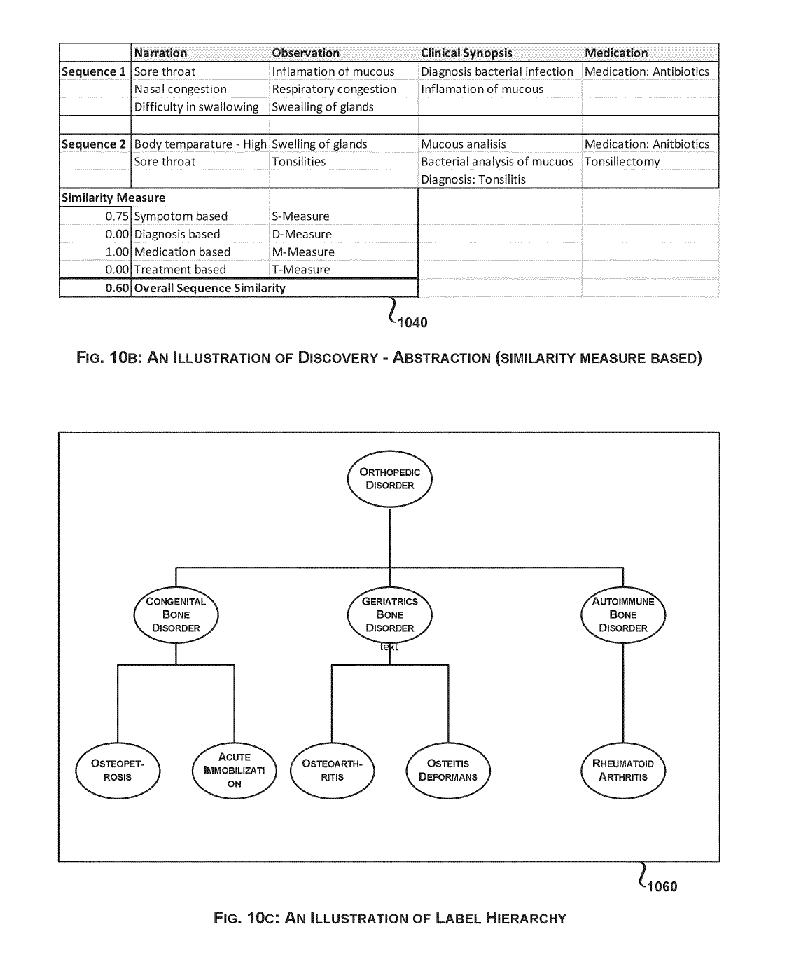

FIG. 10 depicts an illustrative Meta-Cluster. Note that the illustration depicts two sequences—Sequence 1 related to Viral Fever and Sequence 2 related to Typhoid (1000). Based on the set-theoretic union operator, the two sequences are combined to generate a meta-cluster.

FIG. 10A depicts an illustrative MetaFlow. Note that the illustrative metaflow comprises of three meta-nodes (1020): Meta-node 1 is based on actflow1 that is related to Sinusitis; similarly, meta-node 2 is based on the actflow related to Viral Fever while meta-node 3 is based on the actflow related to Typhoid. Typically, such labeled mata-nodes are inter-related temporally, again as depicted.

FIG. 10B provides an illustration of Discovery—Abstraction (similarity measure based). Note that there are two sequences under consideration (1040): both the sequences are described based on their associated pHRs. In the illustration, the similarity measure is defined using four distinct measures: S-measure that is based on similarity with respect to symptoms; D-measure based on diagnosis based similarity; M-measure based on medication similarity; and T-measure based on treatment similarity. And, the overall similarity is obtained by a weighted combination of these individual similarity measures.

FIG. 10C depicts an illustration of Label Hierarchy. Note that this illustrative hierarchy (1060) relates several labels that are used, for example, in labeling the actflows. This kind of hierarchy is used in suitably assigning labels to meta-sequences and meta-clusters.

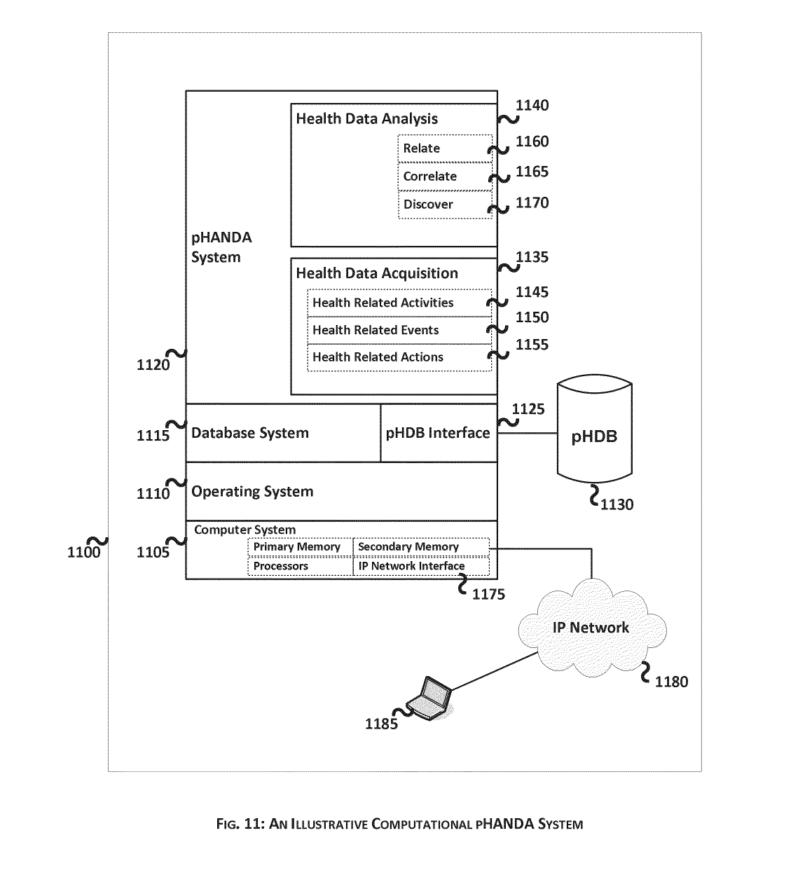

FIG. 11 provides an illustrative elaboration (1100) of computational pHANDA system. In a preferred embodiment, the pHANDA System (1120) is realized on a computer system (1105) with several processors, primary memory units, secondary memory units, and network interfaces, and with an operating system (1110) and a database system (1115). The database system in particular comprises of a component personal Healthcare (pH) DB (database) Interface (1125) to help access pHDB database (1130). As depicted in the figure, the pHANDA System comprises of two key components, namely, Health Data Acquisition Component (1135) and Health Data Analysis Component (1140). The Health Data Acquisition Component helps acquire data associated with the various health related activities (1145), health related events (1150), and health related actions (1155) of an individual. Note that the obtained data is expected to be associated with following six dimensions: Accident (A), Disease (D), Environment (E), Narration (N), Observation (0), and Lifestyle (L). The Health Data Analysis further comprises of the following modules: Relate module (1160), Correlate module (1165), and Discover module (1170). The Relate module analyzes the the raw data obtained from several sources and are mapped onto one or more of the six dimensions, namely, A, D, E, N, O, and/or L. The generated personal health records (pHRs) are updated onto personal Healthcare DB (pHDB). The Correlate module analyzes the pHRs to establish links across pHRs in the multiple six dimensions. Finally, the Discover module analyzes the related and correlated pHRs to derive the meta-information for assisting the individual to be more health conscious.

The IP Network Interface (1175) is used to connect the computer system to an Internet Protocol (IP) Network (1180) so that the individual (user) (1185) can connect and interact with the pHANDA System through the Internet or an intranet.

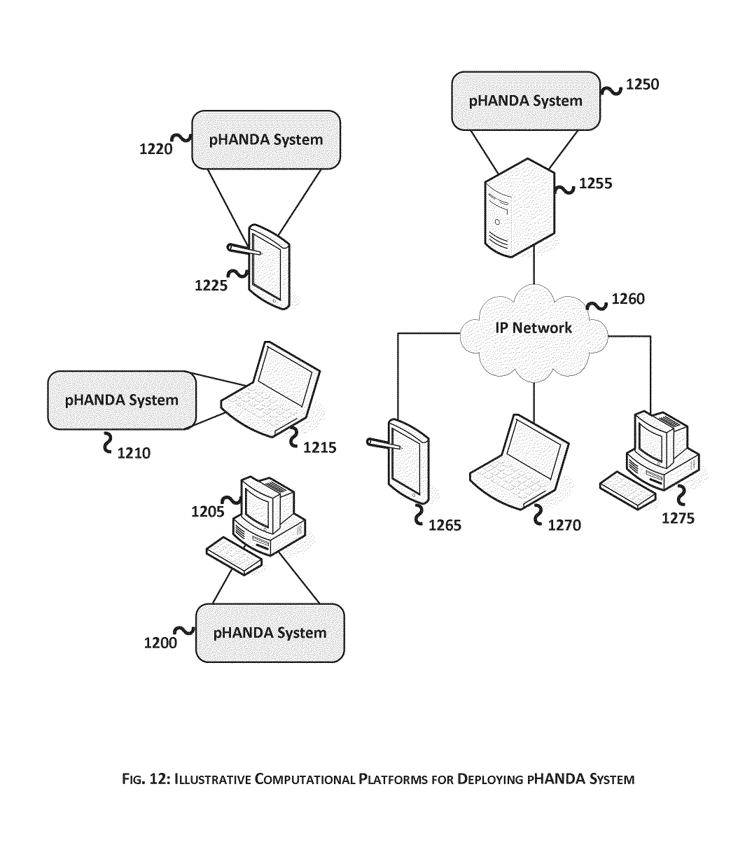

FIG. 12 depicts several computational platforms for deploying pHANDA system. The pHANDA system is a system for the Personal Healthcare Analysis and Distributable Archiving of an individual's health related records. In one of the embodiments, the pHANDA system (1200) gets deployed on a desktop computer (1205). In another embodiment, the pHANDA system (1210) gets deployed on a laptop computer (1215). And in yet another embodiment, the pHANDA system (1220) gets deployed on a smartphone or a digital tablet (1225). Finally, in yet another embodiment, the pHANDA system (1250) gets hosted on a server (1255) as a service and the individual accesses their personalized pHANDA system through the Internet (1260) using a smartphone or digital tablet (1265), a laptop (1270), or a desktop computer (1275).

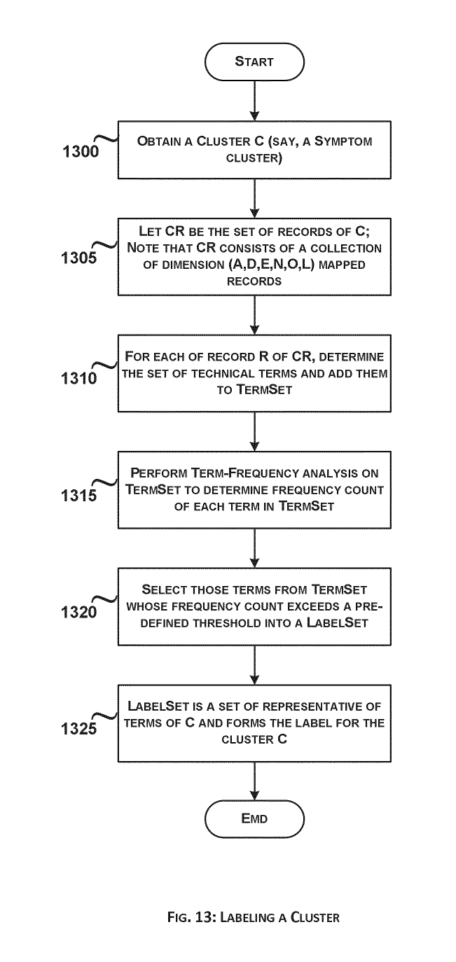

FIG. 13 provides an approach for labeling a cluster of dimension mapped records. A cluster, say a symptom cluster, comprises of a collection of dimension (A, D, E, N, O, L) mapped records that are symptom related. These records comprise of symptom details based on a plurality of health related activities, a plurality of health related events, and a plurality of health related actions. Obtain a Cluster C (say, a Symptom cluster) (1300). Let CR be the set of records of C; note that CR consists of a collection of dimension (A, D, E, N, O, L) mapped records (1305).

For each record R of the set CR, determine the set of technical terms and add them to TermSet; note that these technical terms are obtained based on knowledge sources such as UMLS and SNOMED (1310). Perform the term frequency analysis on TermSet to determine a frequency count of each term in TermSet (1315). Select those terms from TermSet whose frequency count exceeds a pre-defined threshold into a LabelSet (1320). LabelSet is a set of representative of terms of the cluster C and forms the label for the cluster C (1325).

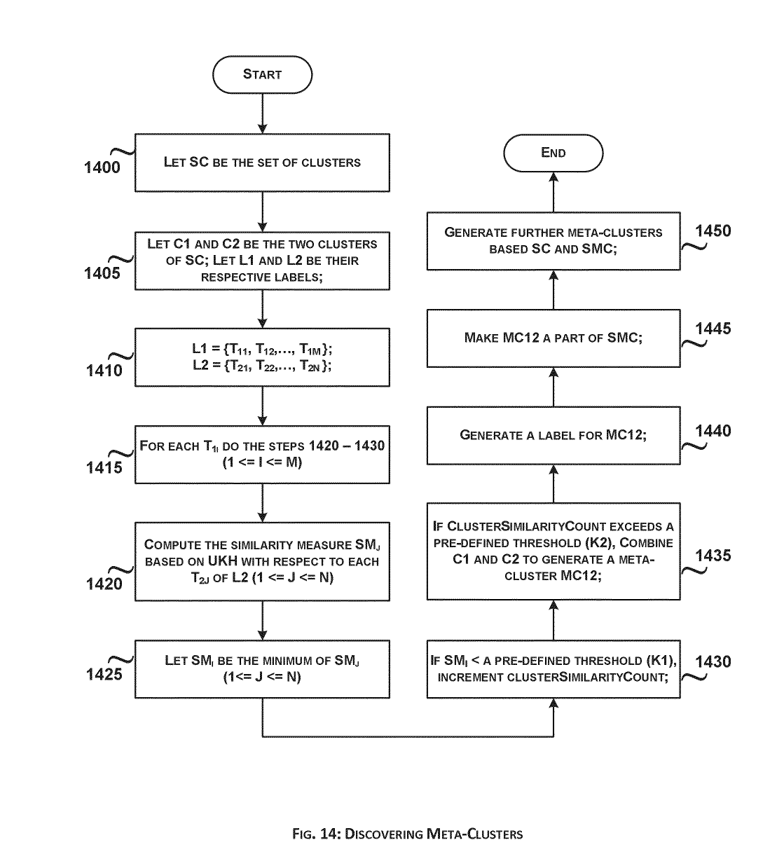

FIG. 14 elaborates on an approach for discovering meta-clusters. The process of discovery generates meta-clusters based on the labeled clusters. Let SC be the set of clusters (1400). Let C1 and C2 be the two clusters of SC and let L1 and L2 be their respective labels (1405). As a label comprises of a set of representative terms, let L1 be {T11, T12, . . . , T1M} and L2 be {T21, T22, . . . , T2N} (1410). For each T1i do the steps 1420-1430 (1<=I<=M) (1415). Compute the similarity measure SMj with respect to each T2j of L2 (1<=J<=N) (1420). Note that SMj is computed using several knowledge sources such as UMLS based knowledge hierarchy (UKH). In a particular embodiment, a number of edges separating two terms T1 and T2 in a knowledge hierarchy is a measure of similarity between T1 and T2. Let SMi be the minimum of SMj (1<=J<=N) (1425). If SMi <=a pre-defined threshold (K1), increase clusterSimilarityCount by 1 (1430). If ClusterSimilarityCount exceeds a pre-defined threshold (K2), Combine C1 and C2 to generate a meta-cluster MC12 (1435). Generate a label for MC12 (1440) as described previously (refer to FIG. 13). Make MC12 a part of the set of meta-clusters SMC (1445). Generate further meta-clusters based SC and SMC (1450).

Thus, a system and method for the analysis and distributable archiving of personal health records is disclosed. Although the present invention has been described particularly with reference to the figures, it will be apparent to one of the ordinary skill in the art that the present invention may appear in any number of systems that perform analysis of person-centric health records. It is further contemplated that many changes and modifications may be made by one of ordinary skill in the art without departing from the spirit and scope of the present invention.

We claim:

1. A computer-implemented method for the analysis and distributable archiving of a plurality of raw data records of a person to construct a personal health database of said person, wherein said plurality of raw data records is related to a plurality of health related activities, a plurality of health related events, and a plurality of health related actions associated with said person, and said personal health database comprising
said plurality of raw data records,
a plurality of dimension mapped records of said plurality of raw data records,
a plurality of clusters of said plurality of dimension mapped records, and
a plurality of meta-clusters of said plurality of clusters,
said computer-implemented method performed on a computer system comprising at least one processor, one or more memory units, and one or more network interfaces for connecting said computer system to an Internet Protocol (IP) network,
said computer-implemented method comprising the steps of:
relating, with at least one processor, said plurality of raw data records to determine said plurality of dimension mapped records based on
a plurality of dimensions, wherein said plurality of dimensions comprises of an accident dimension, a disease dimension, an environment dimension, a narration dimension, an observation dimension, and a lifestyle dimension,
a plurality of accident sub-dimensions of said accident dimension comprising a minor-domestic sub-dimension, a potentially fatal sub-dimension, and a self inflicted sub-dimension,
a plurality of disease sub-dimensions of said disease dimension comprising a chronic sub-dimension, and a life threatening sub-dimension,
a plurality of environment sub-dimensions of said environment dimension comprising an epidemic sub-dimension, a viral contagious sub-dimension, and an occupational sub-dimension,
a plurality of narration sub-dimensions of said narration dimension comprising a clinical sub-dimension, a laboratory sub-dimension, a personal sub-dimension, and an in-patient sub-dimension,
a plurality of observation sub-dimensions of said observation dimension comprising a descriptive sub-dimension and a measurable sub-dimension, and
a plurality of lifestyle sub-dimensions of said lifestyle dimension comprising fitness health sub-dimension, a disease potential sub-dimension, and an addictions sub-dimension;
correlating, with at least one processor, said plurality of dimension mapped records to determine said plurality of clusters;
discovering, with at least one processor, said plurality of meta-clusters based on said plurality of clusters; and
forming, with at least one processor, said personal health database based on said plurality of raw data records, said plurality of dimension mapped records, said plurality of clusters, and said plurality of meta-clusters.

2. The method of claim 1, wherein said step for relating further comprising the steps of:
determining a raw data record of said plurality of raw data records, wherein said raw data record is a self description data record, said self description data record is based on the description, of
an activity of said plurality of health related activities, an event of said plurality of health related events, or an action of said plurality of health related actions, by said person, and said self description data record comprises of an ache description, a sensation description, and a condition description;
performing textual analysis of said raw data record to determine a description of said raw data record, wherein said description is said ache description;
determining a personal narration record based on said raw data record, wherein a dimension of said personal narration record is said narration dimension and a sub-dimension of said personal narration record is said personal sub-dimension;
making said personal narration record a part of said plurality of dimension mapped records;
determining a personal lifestyle record based on said raw data record, wherein a dimension of said personal lifestyle record is said lifestyle dimension and an activity of said plurality of personal health related activities associated with said raw data record is one of a plurality of lifestyle activities comprising jogging;
making said personal lifestyle record a part of said plurality of dimension mapped records;
determining a personal environment record based on said raw data record, wherein a dimension of said personal environment record is said environment dimension and an activity of said plurality of personal health related activities associated with said raw data record is one of a plurality of environment activities comprising climbing staircase;
making said personal environment record a part of said plurality of dimension mapped records;
determining a personal accident record based on said raw data record, wherein a dimension of said personal accident record is said accident dimension and a sub-dimension of said personal environment record is said minor-domestic sub-dimension, and an activity of said plurality of personal health related activities associated with said raw data record is one of a plurality of accident activities comprising accident in kitchen; and
making said personal accident record a part of said plurality of dimension mapped records.

3. The method of claim 2, wherein said step further comprising the steps of:
performing textual analysis of said raw data record to determine a description of said raw data record, wherein said description is said sensation description;
determining a personal narration record based on said raw data record, wherein a dimension of said personal narration record is said narration dimension and a sub-dimension of said personal narration record is said personal sub-dimension;
making said personal narration record a part of said plurality of dimension mapped records;
determining a personal lifestyle record based on said raw data record, wherein a dimension of said personal lifestyle record is said lifestyle dimension and an activity of said plurality of personal health related activities associated with said raw data record is one of said plurality of lifestyle activities;
making said personal lifestyle record a part of said plurality of dimension mapped records;
determining a personal environment record based on said raw data record, wherein a dimension of said personal environment record is said environment dimension and an activity of said plurality of personal health related activities associated with said raw data record is one of said plurality of environment activities;
making said personal environment record a part of said plurality of dimension mapped records;
determining a personal accident record, wherein a dimension of said personal accident record is said accident dimension and a sub-dimension of said personal environment record is said minor-domestic sub-dimension, and an activity of said plurality of personal health related activities associated with said raw data record is one of said plurality of accident activities; and
making said personal accident record a part of said plurality of dimension mapped records.

4. The method of claim 2, wherein said step further comprising the steps of:
performing textual analysis of said raw data record to determine a description of said raw data record, wherein said description is said condition description;
determining a personal narration record based on said raw data record, wherein a dimension of said personal narration record is said narration dimension and a sub-dimension of said personal narration record is said personal sub-dimension;
making said personal narration record a part of said plurality of dimension mapped records;
determining a personal lifestyle record based on said raw data record, wherein a dimension of said personal lifestyle record is said lifestyle dimension and an activity of said plurality of personal health related activities associated with said raw data record is one of said plurality of lifestyle activities;
making said personal lifestyle record a part of said plurality of dimension mapped records;
determining a personal environment record based on said raw data record, wherein a dimension of said personal environment record is said environment dimension and an activity of said plurality of personal health related activities associated with said raw data record is one of said plurality of environment activities;
making said personal environment record a part of said plurality of dimension mapped records;
determining a personal accident record, wherein a dimension of said personal accident record is said accident dimension and a sub-dimension of said personal environment record is said minor-domestic sub-dimension, and an activity of said plurality of personal health related activities associated with said raw data record is one of said plurality of accident activities; and
making said personal accident record a part of said plurality of dimension mapped records.

5. The method of claim 2, wherein said step further comprising the steps of:
determining a raw data record of said plurality of raw data records, wherein said raw data record is an hospital record, said hospital record is a formal description based on an activity of said plurality of health related activities, an event of said plurality of health related events, or an action of said plurality of health related actions, related to said person by an hospital;
performing textual analysis of said raw data record to determine a plurality of electronic health records;
determining a personal disease record based on an electronic health record of said plurality of electronic health records, wherein a dimension of said personal disease record is said disease dimension and said electronic health record is related to a disease;
making said personal disease record a part of said plurality of dimension mapped records;
determining a personal observation record based on an electronic health record of said plurality of electronic health records, wherein a dimension of said personal observation record is said observation dimension and said electronic health record is related to a test report;
making said personal observation record a part of said plurality of dimension mapped records;
determining a personal accident record based on an electronic health record of said plurality of electronic health records, wherein a dimension of said personal accident record is said accident dimension and said electronic health record is related to an accident; and
making said personal accident record a part of said plurality of dimension mapped records.

6. The method of claim 2, wherein said step further comprising the steps of:
determining a raw data record of said plurality of raw data records, wherein said raw data record is a physician description, said physician description is a description based on an activity of said plurality of health related activities, an event of said plurality of health related events, or an action of said plurality of health related actions, related to said person by a physician, and said physician description comprises of a formal description and an informal description;
performing textual analysis of said raw data record to determine a plurality of electronic health records, wherein a description of said raw data record is said formal description;
determining a personal disease record based on an electronic health record of said plurality of electronic health records, wherein a dimension of said personal disease record is said disease dimension and said electronic health record is related to a disease;
making said personal disease record a part of said plurality of dimension mapped records;
determining a personal observation record based on an electronic health record of said plurality of electronic health records, wherein a dimension of said personal observation record is said observation dimension and said electronic health record is related to a test report;
making said personal observation record a part of said plurality of dimension mapped records;
determining a personal accident record based on an electronic health record of said plurality of electronic health records, wherein a dimension of said personal accident record is said accident dimension and said electronic health record is related to an accident; and
making said personal accident record a part of said plurality of dimension mapped records.

7. The method of claim 6, wherein said step further comprising the steps of:
performing textual analysis of said raw data record to determine a description of said raw data record, wherein said description is said informal description;
determining a personal narration record based on said raw data record, wherein a dimension of said personal narration record is said narration dimension and a sub-dimension of said personal narration record is said clinical sub-dimension;
making said personal narration record a part of said plurality of dimension mapped records;
determining a personal accident record based said raw data record, wherein a dimension of said personal accident record is said accident dimension and said raw data record is related to an accident; and
making said personal accident record a part of said plurality of dimension mapped records.

8. The method of claim 2, wherein said step further comprising the steps of:
determining a raw data record of said plurality of raw data records, wherein said raw data record is a nurse description, said nurse description is a description based on an activity of said plurality of health related activities, an event of said plurality of health related events, or an action of said plurality of health related actions, related to said person by a nurse, and said nurse description comprises of a formal description and an informal description;
performing textual analysis of said raw data record to determine a plurality of electronic health records, wherein a description of said raw data record is said formal description;
determining a personal disease record based on an electronic health record of said plurality of electronic health records, wherein a dimension of said personal disease record is said disease dimension and said electronic health record is related to a disease;
making said personal disease record a part of said plurality of dimension mapped records;
determining a personal observation record based on an electronic health record of said plurality of electronic health records, wherein a dimension of said personal observation record is said observation dimension and said electronic health record is related to a test report;
making said personal observation record a part of said plurality of dimension mapped records;
determining a personal accident record based on an electronic health record of said plurality of electronic health records, wherein a dimension of said personal accident record is said accident dimension and said electronic health record is related to an accident; and
making said personal accident record a part of said plurality of dimension mapped records.

9. The method of claim 8, wherein said step further comprising the steps of:
performing textual analysis of said raw data record to determine a description of said raw data record, wherein said description is said informal description;
determining a personal narration record based on said raw data record, wherein a dimension of said personal narration record is said narration dimension and a sub-dimension of said personal narration record is said in-patient sub-dimension; and
making said personal narration record a part of said plurality of dimension mapped records.

10. The method of claim 2, wherein said step further comprising the steps of:
determining a raw data record of said plurality of raw data records, wherein said raw data record is a diagnostic report, said diagnostic report is a formal description based on an activity of said plurality of health related activities, an event of said plurality of health related events, or an action of said plurality of health related actions, related to said person made in a laboratory associated with a hospital;
performing textual analysis of said raw data record to determine a plurality of electronic health records;
determining a personal observation record based on an electronic health record of said plurality of electronic health records, wherein a dimension of said personal observation record is said observation dimension and said electronic health record is related to a test report; and
making said personal observation record a part of said plurality of dimension mapped records.

11. The method of claim 2, wherein said step further comprising the steps of:
determining a raw data record of said plurality of raw data records, wherein said raw data record is an environment report, said environment report is formal description of an environment associated with an activity of said plurality of health related activities, an event of said plurality of health related events, or an action of said plurality of health related actions, related to said person, said environment comprises of an hospital environment, an office environment, a school environment, a home environment, and a place of living environment, and said environment report comprises of a formal description and an informal description;
performing textual analysis of said raw data record to determine a plurality of electronic health records, wherein a description of said raw data record is said formal description;
determining a personal environment record based on an electronic health record of said plurality of electronic health records, wherein a dimension of said personal environmental record is said environment dimension and said electronic health record is related to environment; and
making said personal environment record a part of said plurality of dimension mapped records.

12. The method of claim 11, wherein said step further comprising the steps of:
performing textual analysis of said raw data record to determine a description of said raw data record, wherein said description is said informal description;
determining a personal narration record based on said raw data record, wherein a dimension of said personal narration record is said narration dimension; and
making said personal narration record a part of said plurality of dimension mapped records.

13. The method of claim 2, wherein said step further comprising the steps of:
determining a raw data record of said plurality of raw data records, wherein said raw data record is a lifestyle report, said lifestyle report is a formal description based on an activity of said plurality of health related activities, an event of said plurality of health related events, or an action of said plurality of health related actions, related to a lifestyle of said person, said lifestyle comprises of a food information, clothing information, a hygiene information, and a fitness information, and said lifestyle report comprises of a formal description and an informal description;
performing textual analysis of said raw data record to determine a plurality of electronic health records, wherein a description of said raw data record is said formal description;
determining a personal lifestyle record based an electronic health record of said plurality of electronic health records, wherein a dimension of said personal lifestyle record is said lifestyle dimension and said electronic health record is related to lifestyle; and
making said personal lifestyle record a part of said plurality of dimension mapped records.

14. The method of claim 13, wherein said step further comprising the steps of:
performing textual analysis of said raw data record to determine a description of said raw data record, wherein said description is said informal description;
determining a personal narration record based on said raw data record, wherein a dimension of said personal narration record is said narration dimension; and
making said personal narration record a part of said plurality of dimension mapped records.

15. The method of claim 1, wherein said step for correlating to compute said plurality of clusters further comprising the steps of:
determining a plurality of link dimensions, wherein said plurality of link dimensions comprises of a symptom link dimension, a medication link dimension, a treatment link dimension, a physician link dimension, a temporal link dimension, and a spatial link dimension;
determining a plurality of labels associated with said plurality of link dimensions, wherein said plurality of labels comprising of a symptom label, a medication label, a treatment label, a physician label, a temporal label, and a spatial label;
obtaining a plurality of symptom characteristics associated with said symptom link dimension;
determining a plurality of symptom personal health records based on said plurality of dimension mapped records, wherein each of said plurality of symptom personal health records satisfies said plurality of symptom characteristics;
determining a first symptom personal health record based on said plurality of symptom personal health records;
making said first symptom personal health record a part of a plurality of related symptom personal health records;
associating said symptom label with said plurality of related symptom personal health records;
obtaining a plurality of symptom neighborhood rules based on said symptom link dimension;
determining a second symptom personal health record of said plurality of symptom personal health records based on a second related symptom personal health record of said plurality of related symptom personal health records, wherein said second symptom personal health record and said second related symptom personal health record satisfy said plurality of symptom neighborhood rules;
making said second symptom personal health record a part of said plurality of related symptom personal health records;
making said plurality of related symptom personal health records a part of a plurality of symptom clusters; and
making said plurality of symptom clusters a part of said plurality of clusters.

16. The method of claim 15, wherein said step further comprising the steps of:
obtaining a plurality of medication characteristics associated with said medication link dimension;
determining a plurality of medication personal health records based on said plurality of dimension mapped records, wherein each of said plurality of medication personal health records satisfies said plurality of medication characteristics;
determining a first medication personal health record based on said plurality of medication personal health records;
making said first medication personal health record a part of a plurality of related medication personal health records;
associating said medication label with said plurality of related medication personal health records;
obtaining a plurality of medication neighborhood rules based on said medication link dimension;
determining a second medication personal health record of said plurality of medication personal health records based on a second related medication personal health record of said plurality of related medication personal health records, wherein said second medication personal health record and said second related medication personal health record satisfy said plurality of medication neighborhood rules;
making said second medication personal health record a part of said plurality of related medication personal health records;
making said plurality of related medication personal health records a part of a plurality of medication clusters; and
making said plurality of medication clusters a part of said plurality of clusters.

17. The method of claim 15, wherein said step further comprising the steps of
obtaining a plurality of treatment characteristics associated with said treatment link dimension;
determining a plurality of treatment personal health record based on said plurality of dimension mapped records, wherein each of said treatment personal health record satisfies said plurality of treatment characteristics;
determining a first treatment personal health record based on said plurality of treatment personal health records;
making said first treatment personal health record a part of a plurality of related treatment personal health records;
associating said treatment label with said plurality of related treatment personal health records;
obtaining a plurality of treatment neighborhood rules based on said treatment link dimension;
determining a second treatment personal health record of said plurality of treatment personal health records based on a second related treatment personal health record of said plurality of related treatment personal health records, wherein said second treatment personal health record and said second related treatment personal health record satisfy said plurality of treatment neighborhood rules;
making said second treatment personal health record a part of said plurality of related treatment personal health records;
making said plurality of related treatment personal health records a part of a plurality of treatment clusters; and
making said plurality of treatment clusters a part of said plurality of clusters.

18. The method of claim 15, wherein said step further comprising the steps of
obtaining a plurality of physician characteristics associated with said physician link dimension;
determining a plurality of physician personal health record based on said plurality of dimension mapped records, wherein each of said plurality of physician personal health records satisfies said plurality of physician characteristics;
determining a first physician personal health record based on said plurality of physician personal health records;
making said first physician personal health record a part of a plurality of related physician personal health records;
associating said physician label with said plurality of related physician personal health records;
obtaining a plurality of physician neighborhood rules based on said physician link dimension;
determining a second physician personal health record of said plurality of physician personal health records based on a second related physician personal health record of said plurality of related physician personal health records, wherein said second physician personal health record and said second related physician personal health record satisfy said plurality of physician neighborhood rules;
making said second physician personal health record a part of said plurality of related physician personal health records;
making said plurality of related physician personal health records a part of a plurality of physician clusters; and
making said plurality of physician clusters a part of said plurality of clusters.

19. The method of claim 15, wherein said step further comprising the steps of:
obtaining a plurality of temporal characteristics associated with said temporal link dimension;
determining a plurality of temporal personal health records based on said plurality of dimension mapped records, wherein each of said temporal personal health records satisfies said plurality of temporal characteristics;
determining a first temporal personal health record based on said plurality of temporal personal health records;
making said first temporal personal health record a part of a plurality of related temporal personal health records;
associating said temporal label with said plurality of temporal personal health records;
obtaining a plurality of temporal neighborhood rules based on said temporal link dimension;
determining a second temporal personal health record of said plurality of temporal personal health records based on a second related temporal personal health record of said plurality of related temporal personal health records, wherein said second temporal personal health record and said second related temporal personal health record satisfy said plurality of temporal neighborhood rules;
making said second temporal personal health record a part of said plurality of related temporal personal health records;
making said plurality of related temporal personal health records a part of a plurality of temporal clusters; and
making said plurality of temporal clusters a part of said plurality of clusters.

20. The method of claim 15, wherein said step further comprising the steps of:
obtaining a plurality of spatial characteristics associated with said spatial link dimension;
determining a plurality of spatial personal health records based on said plurality of dimension mapped records, wherein each of said spatial personal health records satisfies said plurality of spatial characteristics;
determining a first spatial personal health record based on said plurality of spatial personal health records;
making said first spatial personal health record a part of a plurality of related spatial personal health records;
associating said spatial label with said plurality of related spatial personal health records;
obtaining a plurality of spatial neighborhood rules based on said spatial link dimension;
determining a second spatial personal health record of said plurality of spatial personal health records based on a second related spatial personal health record of said plurality of related spatial personal health records, wherein said second spatial personal health record and said second related spatial personal health record satisfy said plurality of spatial neighborhood rules;
making said second spatial personal health record a part of said plurality of related spatial personal health records;
making said plurality of related spatial personal health records a part of a plurality of spatial clusters; and
making said plurality of spatial clusters a part of said plurality of clusters.

21. A method of claim 1, wherein said step for discovering said plurality of meta-clusters further comprising the steps of:
determining a first cluster of said plurality of clusters;
determining a first label of said first cluster, wherein a plurality of first representative terms is said first label;
determining a second cluster of said plurality of clusters;
determining a second label of said second cluster, wherein a plurality of second representative terms is said second label;
determining a first term of said plurality of first representative terms;
determining a second term of said plurality of second representative terms;
computing a first similarity measure between said first term and said second term based on a knowledge hierarchy;
computing a plurality of similarity measures based on said first term and said plurality of second representative terms, wherein said first similarity measure is a part of said plurality of similarity measures;
computing a minimum similarity measure based on said plurality of similarity measures, wherein said minimum similarity measure is a minimum value among said plurality of similarity measures;
increasing a cluster similarity count by 1 if said minimum similarity measure is less than a first pre-defined threshold;
computing said cluster similarity count based on said plurality of first representative terms and said plurality of second representative terms;
combining said first cluster and said second cluster to form a first meta-cluster if said cluster similarity count exceeds a second pre-defined threshold;
determining a first meta-label based on said first meta-cluster;
associating said first meta-label with said first meta-cluster; and
making said first meta-cluster a part of said plurality of meta-clusters.

22. A method of claim 21, wherein said step for determining said first label as said plurality of first representative terms further comprising the steps of:
determining a plurality of records of said first cluster;
determining a record of said plurality of records;
determining a plurality of record terms based on said record;
determining a plurality of terms based on said plurality of records, wherein said plurality of record terms is a part of said plurality of terms;
performing term-frequency analysis on said plurality of terms to determine a plurality of frequency counts;
selecting a plurality of selected terms based on said plurality of frequency counts, wherein a selected term of said plurality of selected terms is a part of said plurality of terms and a frequency count of said plurality of frequency counts associated with said selected term exceeds a pre-defined threshold; and
making said plurality selected terms a part of said plurality of first representative terms.
